(19) United States
(12) Patent Application Publication
(10) Pub. No.: US 2017/0064488 A1
(43) Pub. Date: Mar. 2, 2017

(54) CUSTOMIZED RESOURCE TYPES FOR MACHINE-TO-MACHINE COMMUNICATION

(71) Applicant: QUALCOMM INCORPORATED, SAN DIEGO, CA (US)

(72) Inventors: WOLFGANG GRANZOW, HEROLDSBERG (DE); JOSEF JOHANNES BLANZ, FORST (DE); NOBUYUKI UCHIDA, TOKYO (JP); PHILIP MICHAEL HAWKES, VALLEY HEIGHTS (AU)

(21) Appl. No.: 15/222,093

(22) Filed: Jul. 28, 2016

Related U.S. Application Data
(60) Provisional application No. 62/210,188, filed on Aug. 26, 2015.

(51) Int. Cl. H04W 4/00; H04L 12/911

(52) U.S. Cl. CPC H04W 4/005; H04L 47/70

(57) ABSTRACT

Techniques are described for providing and using customized resource types for machine-to-machine (M2M) communication. Through the use of customized resource types, machine type communication (MTC) devices may be provided with flexibility to receive and process request messages without prior knowledge of a resource type associated with the request messages. A receiving MTC device or infrastructure node, may receive a request to create a resource from a requesting MTC device via wireless or wired communications technologies. The resource type of the request may be a customized resource type, and the request to create the resource may include a resource reference and a content parameter. The resource reference may include, for example, a Uniform Resource Indicator or a Uniform Resource Locator that may be used by the receiving MTC device to retrieve the data associated with the resource. The receiving MTC device may generate the resource using the retrieved data.

### CROSS REFERENCE

The present application for patent claims priority to U.S. Provisional Patent Application No. 62/210,188 by Granzow et al., entitled “Customized Resource Types for Machine-to-Machine Communication,” filed Aug. 26, 2015, assigned to the assignee hereof.

### BACKGROUND

The following relates generally to wireless communication, and more specifically to customized resource types for machine-to-machine communication.

Machine-to-Machine (M2M) communication or Machine Type Communication (MTC) refers to data communication technologies that allow automated devices to communicate with one another with little or no human intervention. For example, M2M and/or MTC may refer to communications from a device that integrate sensors or meters to measure or capture information and relay that information to a central server or application program that can make use of the information or present the information to humans interacting with the program or application. Such a device may be called a M2M device, an MTC device and/or an MTC user equipment (UE).

MTC devices may be used to collect information or enable automated behavior of machines. Examples of applications for MTC devices include smart metering, inventory monitoring, component control, water level monitoring, equipment monitoring, healthcare monitoring, wildlife monitoring, weather and geological event monitoring, fleet management and tracking, remote security sensing, physical access control, and transaction-based business charging. The market for MTC devices is expected to grow rapidly as industries such as automotive, security, home automation, healthcare, and fleet management employ MTC to increase productivity, manage costs, and/or expand customer services.

MTC devices may use a variety of wired and/or wireless communication technologies. For example, MTC devices may communicate with a network over various wireless cellular technologies and/or various wireless networking technologies (e.g., IEEE 802.11 (Wi-Fi), IEEE 802.16 (WiMAX), etc.). MTC devices may also communicate with one another using various existing sector or industry solutions for peer-to-peer technologies such as Bluetooth, ZigBee, AllJoyn, Open Internet Consortium (OIC), Open Mobile Alliance (OMA) Lightweight M2M (LWM2M) protocol and/or other ad-hoc or mesh network technologies. The expansion of multiple access wireless networks around the world has made it far easier for MTC communication to take place and has lessened the amount of power and time necessary for information to be communicated between machines. These networks may also allow an array of new business opportunities and connections between consumers and producers in terms of the products being sold.

Such existing sector or industry solutions may present obstacles for communication with MTC devices that communicate with different technologies. For example, a piece of equipment or a smart meter may be deployed and enabled with a first M2M communication technology. Furthermore, the piece of equipment or smart meter may have a relatively long service life, such as 20 years or more. As technology evolves, and as other providers of equipment or smart meters deploy MTC devices, newer or different models of the equipment or smart meter may use a different M2M communication technology. Thus, in order to efficiently communicate with such different M2M communication technologies, a certain specification may be employed.

One such set of specifications is known as oneM2M, which is a set of specifications that help enable users to build platforms for M2M communication regardless of existing sector or industry solutions, extending the existing sector or industry solutions to extend their reach. For example, a single building or local area solution can be left in place and enhanced with oneM2M specifications that help enable wider integration across different MTC devices through exchange of data between different entities in different domains. The oneM2M specifications provide resource-based communication where request messages exchanged between oneM2M entities trigger specific operations on instances of standardized resources. However, as the number of different M2M resource types expand, resource trees that represent native applications can become relatively complex and produce relatively large overhead. Thus, techniques for flexible incorporation of resource types into M2M communications specifications may be desirable.

### SUMMARY

The described features generally relate to one or more improved systems, methods, and/or apparatuses for customized resource types for machine-to-machine (M2M) communication. In some aspects, a machine type communication (MTC) device employing techniques described herein may process request messages having customized resource types in the absence of advance knowledge about the customized resource type. In some examples, a first MTC device, or infrastructure node, may receive a request from a second MTC device to create a resource, in which the resource type of the request may be a customized resource type. The request to create the resource may include a resource reference and a content parameter, and the first MTC device may retrieve data associated with the resource from a first server, using the resource reference. The resource reference may include, for example, a Uniform Resource Indicator (URI) or a Uniform Resource Locator (URL) that may be used by the first MTC device to retrieve the data associated with the resource. The first MTC device may generate the resource using the retrieved data, and may send a response message including the content parameter to the second MTC device.

In some examples, the first MTC device may receive a subsequent request from the second MTC device to create the resource, or a third MTC device, and the first MTC device may then create a second instance of the resource using previously retrieved data from the first server. In some examples generating the resource using the retrieved data includes generating a binding that enables the first MTC device to validate a resource representation with respect to a cardinality, a data type and a parameter value range, and that specifies how the resource is transported in request and response messages using an M2M communication protocol associated with the first MTC device and the second MTC device. In some examples sending the response message to the second MTC device includes publishing an indication of the resource at a second server that is responsive to a first topic published at the second server. The first MTC device may then publish a second topic that indicates an availability of the resource for subscription by the second MTC device or other MTC devices.

In some examples, security may be provided for one or more MTC devices that access the resource by the first server determining that the data is safe for use by the first MTC device. For example, the first server may determine that the data is safe for use by the first MTC device based on one or more of, for example, testing applied by the first server, obtaining information from another server, obtaining implementation information from the first MTC device (e.g., one or more identifiers for the software executing on the first MTC device or one or more identifiers of hardware of the first MTC device). The first server may return an appropriate indication to the first MTC device if it is determined that the data is unsafe for use by the first MTC device, safe for use by the first MTC device, or that the first server is unable to determine whether the data is safe or unsafe for use by the first MTC device.

A method of wireless communication is described. The method may include receiving a request from a second MTC device to create a resource, the request comprises a resource reference and a content parameter, retrieving data associated with the resource from a first server, the data is retrieved using the resource reference, generating the resource using the retrieved data, and sending a response message comprising the content parameter to the second MTC device.

An apparatus for wireless communication is described. The apparatus may include means for receiving a request from a second MTC device to create a resource, the request comprises a resource reference and a content parameter, means for retrieving data associated with the resource from a first server, the data is retrieved using the resource reference, means for generating the resource using the retrieved data, and means for sending a response message comprising the content parameter to the second MTC device.

A further apparatus for wireless communication is described. The apparatus may include a processor, memory in electronic communication with the processor, and instructions stored in the memory and operable, when executed by the processor, to cause the apparatus to receive a request from a second MTC device to create a resource, the request comprises a resource reference and a content parameter, retrieve data associated with the resource from a first server, the data is retrieved using the resource reference, generate the resource using the retrieved data, and send a response message comprising the content parameter to the second MTC device.

A non-transitory computer-readable medium storing code for wireless communication is described. The code may include instructions executable to receive a request from a second MTC device to create a resource, the request comprises a resource reference and a content parameter, retrieve data associated with the resource from a first server, the data is retrieved using the resource reference, generate the resource using the retrieved data, and send a response message comprising the content parameter to the second MTC device.

Some examples of the method, apparatuses, or non-transitory computer-readable medium described herein may further include processes, features, means, or instructions for creating a first instance of the resource using the content parameter. Additionally or alternatively, some examples may include processes, features, means, or instructions for receiving a subsequent request from the second MTC device or a third MTC device to create the resource, the subsequent request comprises the content parameter, and creating a second instance of the resource using the content parameter. In some examples of the method, apparatuses, or non-transitory computer-readable medium described herein the content parameter may include the resource reference.

Some examples of the method, apparatuses, or non-transitory computer-readable medium described herein may further include processes, features, means, or instructions for connecting to a second sever that supports communication between the first MTC device and the second MTC device, and subscribing to a first topic published at the second server, the request to create the resource is received based at least in part on the subscription to the first topic. Additionally or alternatively, in some examples the first server comprises a web server and the second server comprises a server that communicates using a machine-to-machine (M2M) communication protocol associated with the first MTC device and the second MTC device.

In some examples of the method, apparatuses, or non-transitory computer-readable medium described herein, generating the resource using the retrieved data comprises generating a binding that specifies how the response message is transported using an machine-to-machine (M2M) communication protocol associated with the first MTC device and the second MTC device. Additionally or alternatively, in some examples sending the response message to the second MTC device comprises publishing an indication of the resource at the second server, the indication is responsive to the first topic published at the second server.

Some examples of the method, apparatuses, or non-transitory computer-readable medium described herein may further include processes, features, means, or instructions for publishing a second topic that indicates an availability of the resource for subscription by the second MTC device or other MTC devices. Additionally or alternatively, in some examples the first MTC device or the second MTC device comprises the second server.

In some examples of the method, apparatuses, or non-transitory computer-readable medium described herein, the second server comprises an MQTT server. Additionally or alternatively, in some examples receiving the request to create the resource from the second MTC device comprises receiving the request at a first layer entity of the first MTC device from a second layer entity of the second MTC device.

In some examples of the method, apparatuses, or non-transitory computer-readable medium described herein, the first layer entity of the first MTC device includes a service layer entity and the second layer entity of the second MTC device includes an application layer entity. Additionally or alternatively, in some examples the request to create the resource includes a resource type identifier.

In some examples of the method, apparatuses, or non-transitory computer-readable medium described herein, the resource type identifier is selected from a range of resource type identifiers known a priori to the first MTC device and the second MTC device. Additionally or alternatively, in some examples the resource reference comprises a Uniform Resource Indicator (URI), a Uniform Resource Name (URN), or a Uniform Resource Locator (URL).

In some examples of the method, apparatuses, or non-transitory computer-readable medium described herein, the resource reference includes an Extensible Markup Language (XML) Schema Definition (XSD) file, an indication of an XSD file, or a JavaScript Object Notation (JSON) Schema Definition file. Additionally or alternatively, in some examples the content parameter includes a primitive content parameter.

In some examples of the method, apparatuses, or non-transitory computer-readable medium described herein, the content parameter includes at least one of a serialized Extensible Markup Language (XML) data string or a serialized JavaScript Object Notation (JSON) data string. Additionally or alternatively, in some examples the content parameter is supported by protocols at least one of Hypertext Transfer Protocol (HTTP), Constrained Application Protocol (CoAP), MQ Telemetry Transport (MQTT), or Web Socket.

In some examples of the method, apparatuses, or non-transitory computer-readable medium described herein, the request to create the resource is based at least in part on a parent resource associated with the second MTC device, and the resource includes a child resource.

In some examples of the method, apparatuses, or non-transitory computer-readable medium described herein, the retrieving the data using the resource reference comprises determining that the data is safe for use by the first MTC device. In some examples, determining that the data is safe for use by the first MTC device may include one or more of testing the data at the first server, or obtaining information from another server. In some examples, determining that the data is safe for use by the first MTC device may be based at least in part on an implementation of the first MTC device, a software executing on the first MTC device, or a hardware profile for the first MTC device.

In some examples of the method, apparatuses, or non-transitory computer-readable medium described herein, the first server may return an indication to the first MTC device that the first server determined that the data is safe for use by the first MTC device, that the first server determined that the data is unsafe for use by the first MTC device, or that the first server cannot determine whether the data is safe or unsafe for use by the first MTC device. In some examples, the first MTC device may be configured with a list of one or more addresses or identities of first servers through which it may obtain the data. The first MTC device in some examples, upon receiving an indication that one of the servers in the list cannot determine whether the data is safe or unsafe for use by the first MTC device, may request the data from another server in the list of one or more addresses or identities of first servers.

In some examples of the method, apparatuses, or non-transitory computer-readable medium described herein, retrieving the data may include identifying that it cannot be determined whether the data is safe for use if each server in the list cannot determine whether the data is safe, and returning an error indication to the second MTC device.

In some examples of the method, apparatuses, or non-transitory computer-readable medium described herein, the communication between the first MTC device and first server is secure communication. In some examples, the communication between the first MTC device and first server may pass through one or more intermediate devices and be secured on a hop-by-hop basis from one device to the next, or be secured for at least a portion of a communication path between the first MTC device and the first server by end-to-end security. Additionally or alternatively, the first MTC device may be configured with security credentials for establishing secure communication with the first server, or a digital signature may be appended to the data by the first server and verified by the first MTC device.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a wireless network for customized resource types for machine-to-machine (M2M) communication configured in accordance with various aspects of the present disclosure

FIG. 2 illustrates an example of a wireless communications subsystem that supports customized resource types for M2M communication in accordance with various aspects of the present disclosure;

FIG. 3 illustrates an example of entities associated with one or more machine type communication (MTC) devices in different domains that support customized resource types for M2M communication in accordance with various aspects of the present disclosure;

FIG. 4 illustrates an example of communications between different MTC devices in different domains that support customized resource types for M2M communication in accordance with various aspects of the present disclosure;

FIG. 5 illustrates an example of a resource type definition for M2M communication in accordance with various aspects of the present disclosure;

FIG. 6 illustrates an example of a resource tree that supports customized resource types for M2M communication in accordance with various aspects of the present disclosure;

FIG. 7 illustrates an example of a mapping of resource representations that supports customized resource types for M2M communication in accordance with various aspects of the present disclosure;

FIG. 8 illustrates an example of a process flow that supports customized resource types for M2M communication in accordance with various aspects of the present disclosure;

FIG. 9A illustrates an example of a MTC communications subsystem with security aspects in accordance with various aspects of the present disclosure;

FIG. 9B illustrates an example of a MTC communications subsystem with additional security aspects in accordance with various aspects of the present disclosure;

FIG. 10 illustrates an example of a process flow that supports security aspects of customized resource types for M2M communication in accordance with various aspects of the present disclosure;

FIGS. 11-13 show block diagrams of a wireless device that supports customized resource types for M2M communication in accordance with various aspects of the present disclosure;

FIG. 14 illustrates a block diagram of a system including a device that supports customized resource types for M2M communication in accordance with various aspects of the present disclosure;

FIG. 15 illustrates a block diagram of a system including a server device that supports customized resource types for M2M communication in accordance with various aspects of the present disclosure; and

FIGS. 16-21 illustrate methods for customized resource types for M2M communication in accordance with various aspects of the present disclosure.

### DETAILED DESCRIPTION

Techniques are described for providing and using customized resource types for machine-to-machine (M2M) communication. Through the use of customized resource types, machine type communication (MTC) devices may be provided with flexibility to receive and process request messages without prior knowledge of a resource type associated with the request messages. A receiving MTC device or infrastructure node, may receive a request to create a resource from a requesting MTC device via wireless or wired communications technologies. The resource type of the request may be a customized resource type, and the request to create the resource may include a resource reference and a content parameter. The resource reference may include, for example, a Uniform Resource Indicator (URI), a Uniform Resource Name or a Uniform Resource Locator (URL) that may be used by the receiving MTC device to retrieve the data associated with the resource. The receiving MTC device may retrieve data associated with the resource from a server (which may be a server residing in a different logical entity at the receiving MTC device), using the resource reference. The receiving MTC device may generate the resource using the retrieved data, and may send a response message including the content parameter to the requesting MTC device.

In some examples, the receiving MTC device may receive a subsequent request to create the resource from the requesting MTC device, or a different MTC device, and create a second instance of the resource using previously retrieved data from the server. In some examples generating the resource using the retrieved data includes generating a binding that enables the receiving MTC device to validate a resource representation with respect to a cardinality, a data type and a parameter value range, and that specifies how the resource is transported in request and response messages using an M2M communication protocol associated with the receiving MTC device and the requesting MTC device. In some examples sending the response message to the requesting MTC device includes publishing an indication of the resource at a second server that is responsive to a first topic published at the second server. The second server also may be a server residing at a different logical entity of the receiving MTC device. The receiving MTC device may then publish a second topic that indicates an availability of the resource for subscription by the requesting MTC device or other MTC devices.

In some examples, security may be provided for one or more MTC devices that access the resource by the first server determining that the data is safe for use by the first MTC device. For example, the first server may determine that the data is safe for use by the first MTC device based on one or more of, for example, testing applied by the first server, obtaining information from another server, obtaining implementation information from the first MTC device (e.g., one or more identifiers for the software executing on the first MTC device or one or more identifiers of hardware of the first MTC device). The first server may return an appropriate indication to the first MTC device if it is determined that the data is unsafe for use by the first MTC device, safe for use by the first MTC device, or that the first server is unable to determine whether the data is safe or unsafe for use by the first MTC device.

Aspects of the disclosure are initially described in the context of a wireless communication system. Specific examples are then described for systems that employ oneM2M specifications. These and other aspects of the disclosure are further illustrated by and described with reference to apparatus diagrams, system diagrams, and flowcharts that relate to customized resource types for machine-to-machine communication.

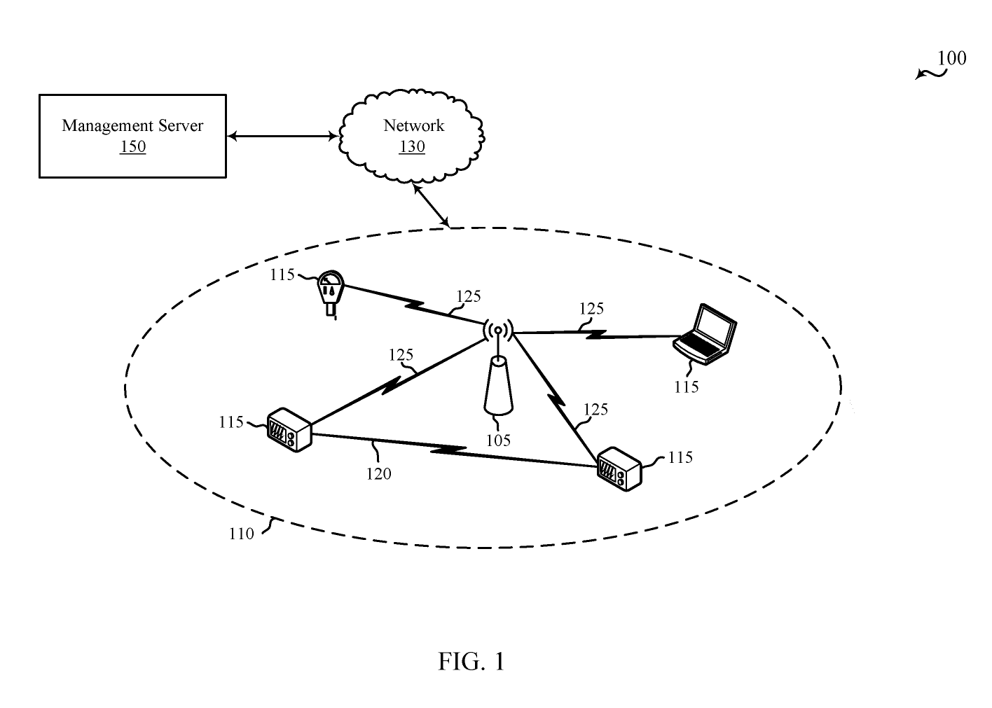

FIG. 1 illustrates a wireless network 100 configured in accordance with various aspects of the present disclosure. In some examples, the wireless network 100 is a wireless local area network (WLAN) 100 (also known as a Wi-Fi network), although techniques described herein may be applied to any type of wireless network (e.g., a cellular communication network or ad-hoc wireless network) or wired communication network. The WLAN 100 may include an access point (AP) 105 and multiple pieces of user equipment (UE) 115, which may represent devices such as MTC devices, mobile stations, personal digital assistant (PDAs), other handheld devices, netbooks, notebook computers, tablet computers, laptops, display devices (e.g., TVs, computer monitors, etc.), printers, etc. The various UEs 115 in the network are able to communicate with one another through the AP 105 via communications links 125, or may communicate directly with other UEs 115 such as through one or more M2M communications protocols.

Wireless communication links 120 may also be established between user equipment (UEs) 115 in a configuration known as device-to-device (D2D) communications. One or more of a group of UEs 115 utilizing M2M communications may be within the coverage area 110 of AP 105. Other UEs 115 in such a group may be outside the coverage area 110, or otherwise unable to receive transmissions from AP 105. In some cases, groups of UEs 115 communicating via M2M communications may utilize a one-to-many (1:M) system in which each UE 115 transmits to every other UE 115 in the group. In some cases, a AP 105 facilitates the scheduling of resources for M2M communications. In other cases, M2M communications are carried out independent of a AP 105.

Some types of wireless devices may provide for automated communication. Automated wireless devices may include those implementing M2M communication or MTC. M2M or MTC may refer to data communication technologies that allow devices to communicate with one another or a AP without human intervention. For example, M2M or MTC may refer to communications from devices that integrate sensors or meters to measure or capture information and relay that information to a central server or application program that can make use of the information or present the information to humans interacting with the program or application. Some UEs 115 may be MTC devices, such as those designed to collect information or enable automated behavior of machines. Examples of applications for MTC devices include smart metering, smart switches, inventory monitoring, water level monitoring, equipment monitoring, healthcare monitoring, wildlife monitoring, weather and geological event monitoring, fleet management and tracking, remote security sensing, physical access control, and transaction-based business charging, to name but a few examples. An MTC device may operate using half-duplex (one-way) communications at a reduced peak rate. MTC devices may also be configured to enter a power saving “deep sleep” mode when not engaging in active communications.

In some aspects of the disclosure, UEs 115 and/or AP 105 may be MTC devices configured to employ custom resource types that provide flexibility to receive and process request messages without prior knowledge of a resource type associated with the request messages. A receiving MTC device or infrastructure node (e.g., AP 105) may receive a request to create a resource from a requesting MTC device (e.g., UE 115) via wireless or wired communications technologies. The resource type of the request may be a customized resource type, and the request to create the resource may include a resource reference and a content parameter. The resource reference may include, for example, a Uniform Resource Indicator (URI), a URN which may be an example of a URI, or a Uniform Resource Locator (URL) that may be used by the receiving MTC device to retrieve the data associated with the resource. The receiving MTC device may retrieve data associated with the resource from a server (which may be a server residing in a different logical entity at the receiving MTC device), using the resource reference. The receiving MTC device may generate the resource using the retrieved data, and may send a response message including the content parameter to the requesting MTC device. In some examples, the receiving device also performs one or more security checks to verify that the data is safe for use.

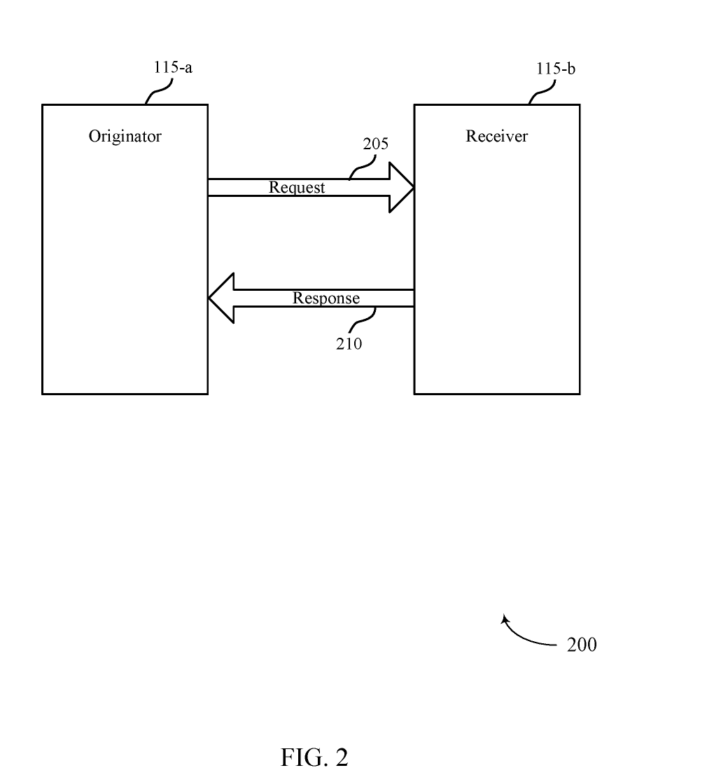

FIG. 2 illustrates an example of a wireless communications subsystem 200 for customized resource types for machine-to-machine communication in accordance with various aspects of the present disclosure. Wireless communications subsystem 200 may include an originating MTC device 115-a and a receiving MTC device 115-b, which may be examples of a UE 115 described with reference to FIG. 1. While the example of FIG. 2 is discussed using two UEs 115, techniques provided in the present disclosure may be used by other network entities, such as an AP 105 of FIG. 1, a cellular communications node (e.g., a base station), or logical entities that may reside in a network node.

As mentioned above, in some examples techniques described herein may be used in a network operating according to oneM2M specifications. The oneM2M architecture provides a number of layers that may operate in a MTC device. One such layer is referred to as a “Service Layer,” which represents “middleware” software sitting between application and transport layers. The service layer may provide communication protocols and Application Programming Interfaces (APIs) employed to exchange data between one or more Application Entities (AEs) and one or more Service Layer Entities, such as a Common Services Entity (CSE). The oneM2M architecture employs resource-based communication where request messages 205 may be transmitted from originator 115-a and received at receiver 115-b to trigger specific operations on instances of standardized resources, which may be referred to as CRUDN operations to:

Create a resource;

Retrieve the content of a resource (all or partially);

Update a resource;

Delete a resource; or

Notify subscribed receivers of changes made on a resource.

The operation result may then be reported with a response message 210 by the request receiver 115-b to the request originator 115-a.

Communication between M2M entities is specified in terms of request and response primitives, which include a set of mandatory and optional primitive parameters as defined by one M2M specifications. Primitives may be represented in form of a serialized Extensible Markup Language (XML) data string or a serialized JavaScript Object Notation (JSON) data string, for example. In some examples, primitives may not be exchanged directly between different M2M Nodes, and may be mapped to binding protocols such as Hypertext Transfer Protocol (HTTP), Constrained Application Protocol (CoAP), MQ Telemetry Transport (MQTT), or Web Socket. An example of a Create request primitive of a <contentInstance> resource is provided below:

```
<?xml version=“1.0” encoding=“UTF-8”?>
<m2m:rqp xmlns:m2m=“http://www.onem2m.org/xml/protocols”
xmlns:xsi=“http://www.w3.org/2001/XMLSchema-instance”
xsi:schemaLocation=“http://www.onem2m.org/xml/protocols
CDT-requestPrimitive-v1_0_0.xsd”>
          <op>1</op>
          <to>//mym2msp.org/CSE18963/base1/AE1735/
          CT2841u378</to>
          <fr>/CAE015</fr>
          <ri>0002bf63</ri>
          <ty>4</ty>
          <pc>
            <m2m:cin rn=“temp754”>
                    <cnf>application/xml:1</cnf>
                    <con>PHRpbWU+MTc4ODkzMDk8L3RpbWU+
PHRlbXA+MjA8L3RlbXA+DQo=</con>
            </m2m:cin>
          </pc>
</m2m:rqp>
```

An exemplary HTTP request corresponding to this request primitive is provided below:

POST //mym2msp.org/CSE18963/base1/AE1735/CT2841u378 HTTP/1.1
Host: 80.188.137.1:8000
Content-Type: application/vnd.onem2m-res+xml; ty=4
Content-Length: 161
X-M2M-Origin: CAE015
X-M2M-RI: 0002bf63
<?xml version=“1.0” encoding=“UTF-8”?><m2m:cin
rn=“temp754”><cnf>application/xml:1</cnf><con>PHRpbWU+
MTc4ODkzMDk8L3RpbWU+PHRlbXA+MjA8L3RlbXA+DQo=</
con></m2m:cin>

As mentioned above, oneM2M (or other M2M communications specifications) may encounter obstacles in defining resource types as technology evolves and new MTC devices are deployed. Resources may be defined according to resource trees that represent native applications of M2M devices, as will be discussed in more detail below, and may become relatively complex and produce large unnecessary overhead due to the common resource attributes for each node of the tree as the number of different types of resource types grow. Various aspects of the present disclosure provide custom resource types that provide flexibility to receive and process request messages without prior knowledge of a resource type associated with the request messages.

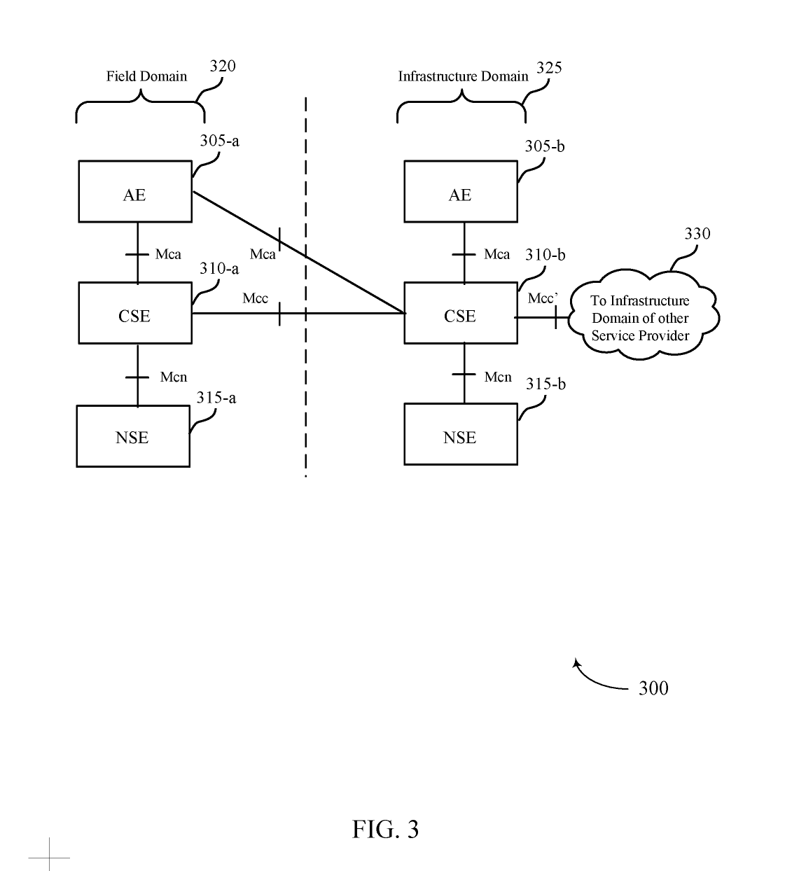

As mentioned above, FIG. 3 illustrates an example 300 of entities associated with one or more machine type communication (MTC) devices in different domains that support customized resource types for M2M communication in accordance with various aspects of the present disclosure. The entities illustrated in example 300 may be present on one or more MTC devices such as a UE 115 or AP 105 described with reference to FIGS. 1-2.

In the example of FIG. 3, MTC devices may be located in a field domain 320 or an infrastructure domain 325. The field domain 320 may correspond to MTC devices that are located at relatively remote locations and that may communicate with one or more infrastructure domain 325 nodes via wireless or wired communications. Nodes in the infrastructure domain 325 may receive communications from MTC devices in the field domain 320, and provide responses to the communications or relay information to/from MTC devices in the field domain from one or more other infrastructure domains 330 of one or more other service providers. MTC devices in the field domain 320 or infrastructure domain 325 may include an application entity (AE) 305, which is an entity in the Application Layer that implements an M2M application service logic. The AE 305 for each MTC device may be identified by a unique AE identification (AE-ID). MTC devices may also include a common services entity (CSE) 310, which is an entity in the Service Layer that implements an M2M service logic. A CSE 310 may represent an instantiation of a set of “common service functions” of the M2M environments, exposed to other entities through the Mca and Mcc reference points. MTC devices may also include a network services entity (NSE) 315, which may provide services from the underlying network to the CSEs 310, and may be exposed to CSEs 310 via Mcn reference point.

Various nodes in an MTC communications network may include one or more entities. In some oneM2M examples, nodes may be comprised of one or more AEs and/or one CSE. The entities in a given node may depend upon the particular type of node. For example, an Application Dedicated Node (ADN) may contain at least one AE and no CSE. An Application Service Node (ASN) may contain one CSE and one or more Application Entity (AE). A Middle Node (MN) may contain one CSE and zero or more Application Entities (AE). Finally, an Infrastructure Node (IN) may include one CSE and zero or more Application Entities (AE). In some deployments, a network service entity (NSE) may be present in one or more underlying wired or wireless network(s) that support communication between MTC devices. As discussed above, although various examples refer to oneM2M, the techniques described herein may be applied to other types of networks.

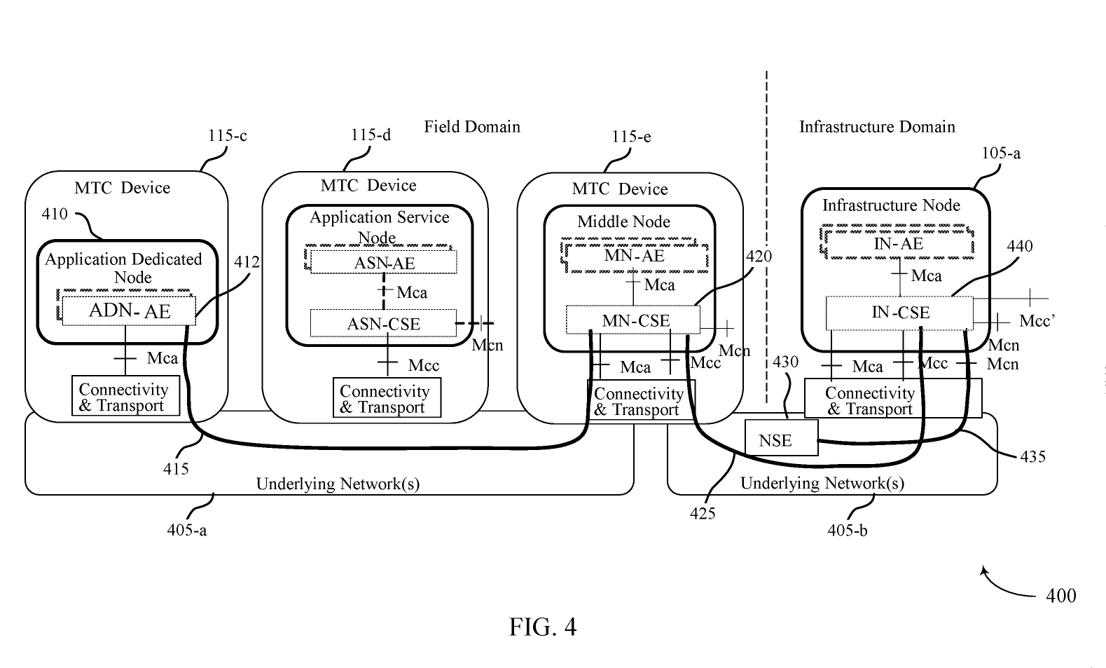

FIG. 4 illustrates an exemplary MTC system 400 showing communications between different MTC devices in different domains that support customized resource types for M2M communication in accordance with various aspects of the present disclosure. MTC system 400 may include a number of MTC devices 115 and an infrastructure node 105-a, which may be examples of UEs 115 and APs 105 described with reference to FIGS. 1-3.

In the MTC system 400 of FIG. 4, a first MTC device 115-c may include an ADN 410 with an associated ADN-AE 412. The first MTC device 115-c may be in a field domain, and communicate with a second MTC device 115-e in the field domain. The field domain may also include other MTC devices, such as third MTC device 115-d. The ADN-AE 412 may establish a communication channel 415 with a MN-CSE 420 of the second MTC device (e.g., via connectivity and transport layers and one or more underlying wireless or wired networks 405-a). In some examples, the ADN-AE 412 may transmit a request to create a custom resource to the MN-CSE 420 of second MTC device 115-e, in which the request may include a resource reference and a content parameter. In some examples, the content parameter may comprise the resource reference. In other examples, the resource reference may comprise the content parameter. In some examples, the request may include only one of the resource reference or the content parameter. The MN-CSE may establish a communication channel 425 with IN-CSE 440 (e.g., via connectivity and transport layers and one or more underlying wireless or wired networks 405-b) to retrieve data associated with the custom resource from a first server, such as an IN-CSE 440 of an infrastructure node 105-a. In some examples, a NSE 430 may facilitate communication with IN-CSE 440 and have a communication channel 435 with IN-CSE 440. The data may be retrieved using the resource reference, such as a URI or URL and facilitated by NSE 430, for example. Custom resources and establishment of custom resources using such resource references and content parameters will be described in more detail below.

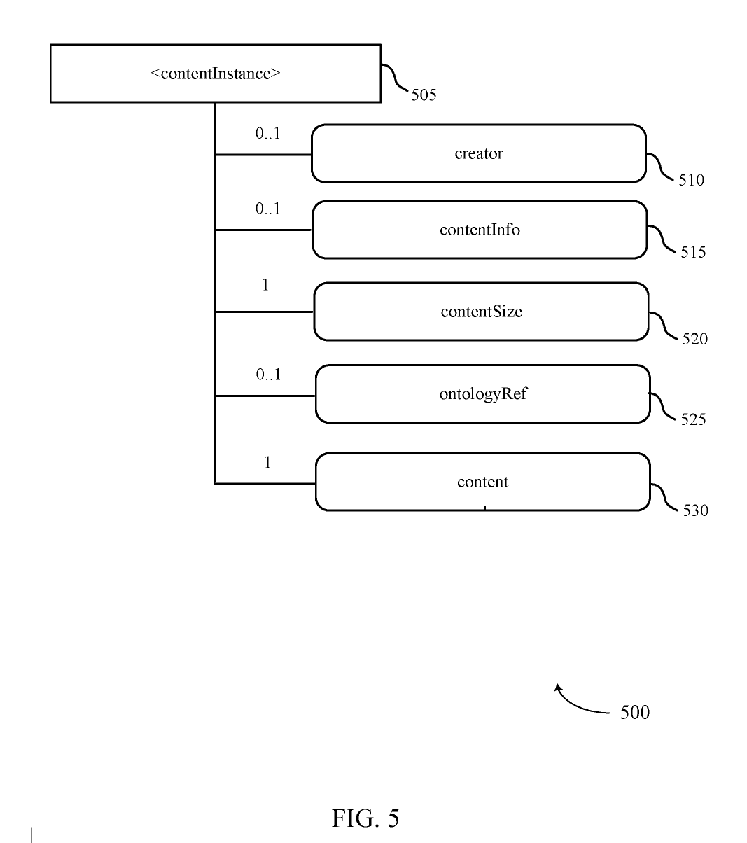

FIG. 5 illustrates an example of a resource type definition 500 for M2M communication in accordance with various aspects of the present disclosure. Resource type definition 500 may be used by MTC devices, such as MTC type UEs 115 and AP MTC devices 105 described with reference to FIGS. 1-4, to create resources for use in MTC communications. Resource types may be defined in terms of their applicable resource attributes and permitted child resources and of their data type definitions, and resource types may be identified by “resourceType” identifiers. In the resource type definition 500 of FIG. 5, an example of a resource type 505 is <contentInstance> (which corresponds to resourceType (ty)=4 in oneM2M). Each resource type is defined in terms of an XML Schema definition, which may include common resource attributes that are provided for all resource types (e.g., oneM2M attributes: resourceType; resourceID; resourceName; parentID; labels; expirationTime; creationTime; lastModifiedTime; stateTag; announceTo; and announcedAttribute). A resource type may also have resource-specific attributes, such as attributes 510-530 illustrated in FIG. 5 (common resource attributes are not illustrated in FIG. 5). In the example of FIG. 5, resource-specific attributes may include a creator attribute 510, a contentInfo attribute 515, a contentSize attribute 520, an ontologyRef attribute 525, and a content attribute 530. Such a schema definition associated with the resource type definition 500 may provide a definition of the resource. However, as discussed above, as technology evolves, having a standard set of schema definitions may result in an unwieldly amount of overhead for an MTC device. Accordingly, provided herein are various examples of custom resource types that may not be known by an MTC device before receiving a request from a requesting device. Upon receipt of such a request, a receiving MTC device may contact a server (which may be another entity of the receiving MTC device or another MTC node).

In the example of oneM2M, an XML Schema Definition (XSD) file may be provided for each existing resource type, and resource representations and data exchanged over Mca and Mcc reference points comply with the associated XSD. According to various examples of the present disclosure, a custom resource type may be provided, with a custom XSD made available through a server that may be identified by a request that is originated by a requesting device. A receiving device may contact the server and retrieve the associated information related to the custom resource type, and use this information for communications with the requesting device. In some examples, s JavaScript Object Notation (JSON) Schema Definition file may be provided for each existing resource type, and resource representations and data exchanged over Mca and Mcc reference points may comply with the associated XSD. According to various examples of the present disclosure, a custom resource type may be provided, with a custom JSON Schema Definition file made available through a server that may be identified by a request that is originated by a requesting device. An example XSD from oneM2M for <contentInstance> is provided below:

<?xml version=“1.0” encoding=“UTF-8”?>
<!--

### Copyright Notification

The oneM2M Partners authorize you to copy this document, provided that you retain all copyright and other proprietary notices contained in the original materials on any copies of the materials and that you comply strictly with these terms.
This copyright permission does not constitute an endorsement of the products or services, nor does it encompass the granting of any patent rights. The oneM2M Partners assume no responsibility for errors or omissions in this document.
© 2015, oneM2M Partners Type 1 (ARIB, ATIS, CCSA, ETSI, TIA, TTA, TTC). All rights reserved.

### Notice of Disclaimer & Limitation of Liability

The information provided in this document is directed solely to professionals who have the appropriate degree of experience to understand and interpret its contents in accordance with generally accepted engineering or other professional standards and applicable regulations. No recommendation as to products or vendors is made or should be implied.
NO REPRESENTATION OR WARRANTY IS MADE THAT THE INFORMATION IS TECHNICALLY ACCURATE OR SUFFICIENT OR CONFORMS TO ANY STATUTE, GOVERNMENTAL RULE OR REGULATION, AND FURTHER, NO REPRESENTATION OR WARRANTY IS MADE OF MERCHANTABILITY OR FITNESS FOR ANY PARTICULAR PURPOSE OR AGAINST INFRINGEMENT OF INTELLECTUAL PROPERTY RIGHTS.
NO oneM2M PARTNER TYPE 1 SHALL BE LIABLE, BEYOND THE AMOUNT OF ANY SUM RECEIVED IN PAYMENT BY THAT PARTNER FOR THIS DOCUMENT, WITH RESPECT TO ANY CLAIM, AND IN NO EVENT SHALL oneM2M BE LIABLE FOR LOST PROFITS OR OTHER INCIDENTAL OR CONSEQUENTIAL DAMAGES. oneM2M EXPRESSLY ADVISES ANY AND ALL USE OF OR RELIANCE UPON THIS INFORMATION PROVIDED IN THIS DOCUMENT IS AT THE RISK OF THE USER.

```
-->
<?xml version=“1.0” encoding=“UTF-8”?>
<xs:schema xmlns=“http://www.w3.org/2001/XMLSchema”
targetNamespace=“http://www.onem2m.org/xml/protocols”
xmlns:m2m=“http://www.onem2m.org/xml/protocols”
xmlns:xsi=“http://www.w3.org/2001/XMLSchema-instance”
elementFormDefault=“unqualified” xmlns:xs=“http://www.w3.org/2001/XMLSchema”>
<xs:include schemaLocation=“CDT-commonTypes-v1_0_0.xsd” />
<xs:element name=“contentInstance”>
  <xs:complexType>
    <xs:complexContent>
    <xs:extension base=“m2m:announceableSubordinateResource”>
      <xs:sequence>
  <!-- Common Attribute, specific to <container>, <contentInstance>, <request> and
<delivery> resources -->
        <xs:element name=“stateTag” type=“xs:nonNegativeInteger” />
        <!-- Resource Specific Attributes -->
        <xs:element name=“creator” type=“m2m:ID” minOccurs=“0” />
        <xs:element name=“contentInfo” type=“m2m:contentInfo” minOccurs=“0” />
        <xs:element name=“contentSize” type=“xs:nonNegativeInteger” />
        <xs:element name=“ontologyRef” type=“xs:anyURI” minOccurs=“0” />
        <xs:element name=“content” type=“xs:anyType” />
      </xs:sequence>
    </xs:extension>
    </xs:complexContent>
  </xs:complexType>
</xs:element>
```

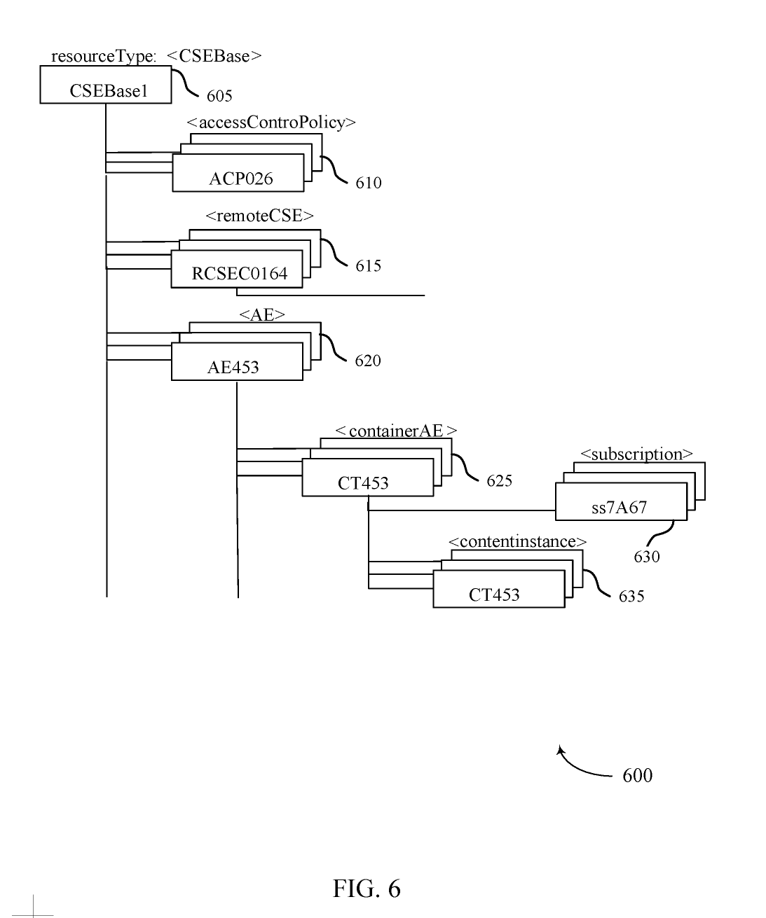

FIG. 6 illustrates an example of a resource tree 600 that supports customized resource types for M2M communication in accordance with various aspects of the present disclosure. Resource tree 600 may be used by MTC devices, such as MTC type UEs 115 and AP MTC devices 105 described with reference to FIGS. 1-5, in MTC communications. A CSE is a MTC system may host a resource tree for a particular resource. Each resource tree starts in a <CSEBase> resource 605. In the example of FIG. 6, the resource tree 600 includes one or more access control policy 610, one or more remote CSE ID 615, one or more AE ID 620, one or more container AE ID 625, one or more subscription ID 630, and one or more content instance 635.

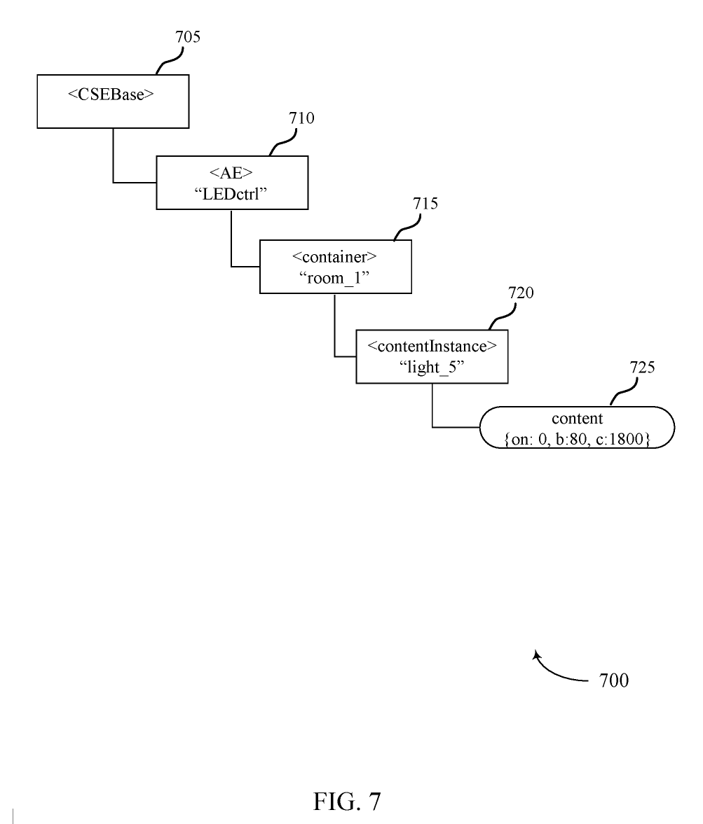

Each application may then be mapped into a resource representation comprised of identified resources, such as standard resources defined in oneM2M, for example. In some examples, this may be generically done using one or more hierarchy levels of <container> resources and of <contentInstance> resources which terminate a branch. A number of different options are available for such a mapping, and FIG. 7 illustrates an example of a mapping of resource representations 700 that supports resource types for M2M communication of a LED light controller in accordance with various aspects of the present disclosure. Resource representations 700 may be used by MTC devices, such as MTC type UEs 115 and AP MTC devices 105 described with reference to FIGS. 1-6, in MTC communications. In the example of FIG. 7, a CSE base ID is provided in 705, an AE is mapped at 710, a container is mapped at 715, a content instance is mapped at 720, and content is mapped at 725.

Various aspects of the present disclosure proposes to give application developers the flexibility to design their own customized resource types, that conform to, for example, oneM2M standards such as discussed above. In some examples, systems may be enabled to handle CRUDN requests on customized resource types, while avoiding the need to pre-standardize, or register these into a registry (e.g., a oneM2M maintained registry), although registration may still be performed in some cases. In such a manner, MTC entities may be capable of processing customized resource types without being prepared in advance for the particular resource type. In some examples, customized resource types may be specified in terms of XSD, which can be downloaded on the fly by a CSE entity when receiving a request. To become able to process such request, the CSE may auto-generate source code from the XSD, which enables it to produce XML or JSON serialized representations of any instantiations of the custom resource-type. In some examples, a set of requirements and constraints may be defined. Such a set may include mandatory and optional common resource attributes, resource types permitted as parent of customized resource types, resource types permitted as children of customized resource types, and a range of applicable resource type identifiers.

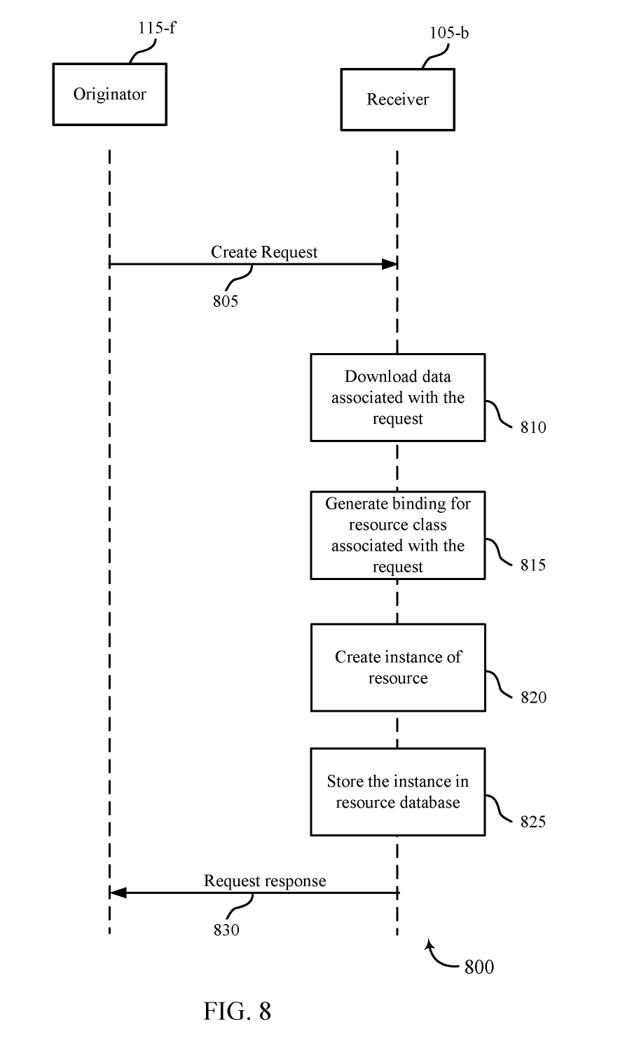

FIG. 8 illustrates an example of a process flow 800 for customized resource types for M2M communication in accordance with various aspects of the present disclosure. Process flow 800 may include an originator device, such as a MTC UE device 115-f and a receiver device, such as an AP MTC device 105-b, which may be examples of UEs 115 and APs 105 described with reference to FIGS. 1-7.

The originator MTC device 115-f may transmit a create request 805 to receiver MTC device 105-b. The create request may be a request to create a customized MTC resource, and may include a resource reference and a content parameter. The receiver MTC device 105-b may receive the create request 805 and download data associated with the resource from a first server (e.g., a CSE at the receiver MTC device 105-b or a server located remote from the receiver MTC device 105-b), according to block 810. In some examples the server may be a web server, and the data may be downloaded, for example, using the resource reference from the create request 805, which in some examples may include a URL or URI for a location of the data. In some examples the create request 805 may include a resource type identifier that may be selected from a range of resource type identifiers known a priori to the receiver MTC device 105-b. At block 815, the receiver MTC device 105-b may generate a binding for a resource class associated with the request, and the binding may enable the MTC device 105-b to validate a resource representation with respect to a cardinality, a data type and a parameter value range, and may specify how the resource is transported in request and response messages. In some examples, receiver MTC device 105-b may subscribe to a topic published at a server (e.g., a CSE at the receiver MTC device 105-b or a server located remote from the receiver MTC device 105-b), and the create request 805 may be received based on the subscription to the first topic.

At block 820, the receiving MTC device 105-b may create an instance of the resource, and at block 825 the instance may be stored in a resource database. The receiver MTC device 105-b may transmit the request response 830 to the originator MTC device 115-f. In some examples sending the request response 830 message to the originator MTC device 115-f may include publishing an indication of the resource at a server that is responsive to a topic published at the server. In some examples, the server may publish a topic that indicates an availability of the resource for subscription by the originator MTC device 115-f or other MTC devices. In some examples the server may be an MQTT server. In some examples, if a create request for the same resource is received again at the receiver MTC device 105-b, the operations of blocks 810 and 815 may be skipped.

In some examples, in order to provide that the receiver MTC device 105-b and originator MTC device 115-f are configured to handle customized resource types, communications specifications (e.g., oneM2M specifications) may include one or more definitions of a range of resource type IDs reserved for customized resource types, and may include the addition of an optional parameter to request primitives, which provides the URI to the XSD file of the customized resource Type and definition of the procedure how to deal with this XSD. In some examples this primitive parameter may be supported by any of the binding protocols (e.g., HTTP, CoAP, MQTT and WebSockets). The communications protocol specifications also may include one or more generic procedures for CRUDN operations on customized resource types, a definition of the applicable parent resources of customized resources, resource discovery and subscription procedures to enable discovery of and subscription to customized resource types, and error handling procedures (e.g. additional response status codes) for entities not supporting customized resource types.

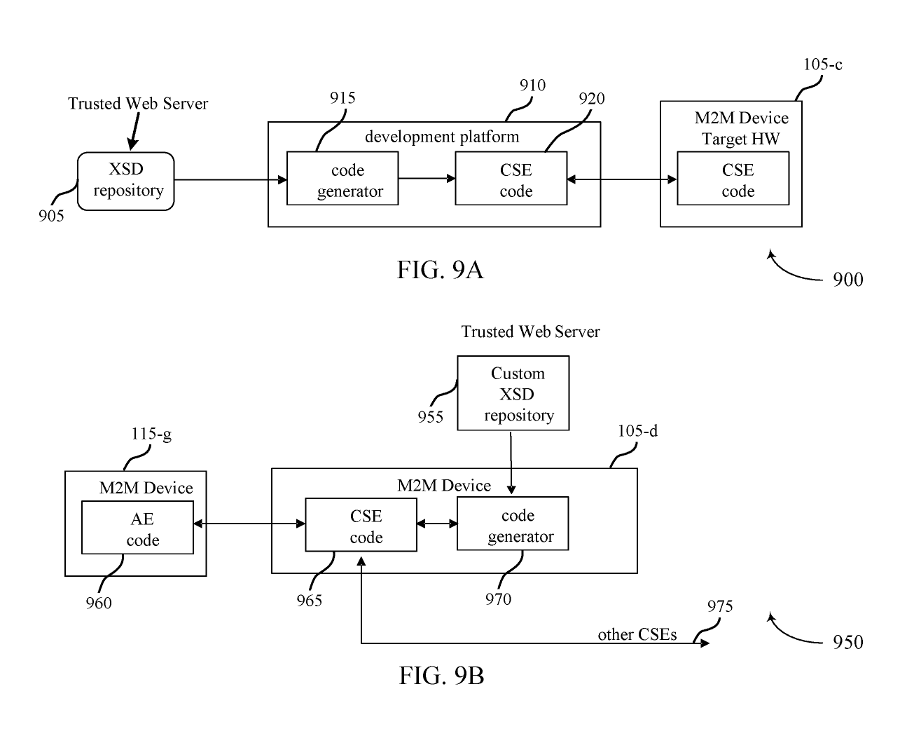

FIG. 9A illustrates an example of a MTC communications subsystem 900 with security aspects in accordance with various aspects of the present disclosure. MTC communications subsystem 900 may include an XSD repository 905 that may reside on a trusted web server. A development platform 910 may access the XSD repository 905, and XSD files may be provided to a code generator 915, which may generate CSE code 920 for use by a CSE of a MTC device 105-c. MTC device 105-c may be an example of an AP MTC device 105 of FIGS. 1-8. While the example of FIG. 9A is discussed with respect to an AP MTC device 105, techniques provided in the present disclosure may be used by other network entities, such as a UE MTC device 115 (or other type of MTC device) of FIGS. 1-8, or logical entities that may reside in a network node. Security may be provided to the MTC device 105-c through the generation of the CSE code 920 at the development platform 910. The code provided to the MTC device 105-c may thus be controlled to provide security and ensure the code is safe to run at the MTC device 105-c.

In other examples, as discussed above, an M2M device may access a server to obtain an XSD file and generate code for a custom resource type. In such examples, additional security may be provided to help ensure the code is safe for the MTC device to run. FIG. 9B illustrates an example of a MTC communications subsystem 950 with additional security aspects in accordance with various aspects of the present disclosure. MTC communications subsystem 900 may include a custom XSD repository 955 that may reside on a trusted web server. Upon receiving a create request at a first MTC device 105-d from a second MTC device 115-g for a custom resource type, the first MTC device 105-d may access the custom XSD repository 955 to obtain an XSD file that may be used by code generator 970 to generate CSE code 965 for the custom resource type. AE code 960 at the second MTC device 115-g may exchange information with a CSE at the first MTC device 105-d in accordance with the custom resource type. First MTC device 105-d may be an example of an AP MTC device 105, and second MTC device 115-g may be an example of a UE MTC device 115, as described above with respect to FIGS. 1-8. While the example of FIG. 9B is discussed with respect to an AP MTC device 105 and a UE MTC device 115, techniques provided in the present disclosure may be used by other network entities or other MTC devices of FIGS. 1-8, or logical entities that may reside in a network node.

Security may be provided to the CSE at the first MTC device 105-d, in some examples, by using a trusted party to provide custom XSD repository 955. For example, the trusted party may compile a database of CSE implementation identifiers and XSDs of customized resource types which have been tested against that implementation. The database may be complied using results of the trusted party's testing and/or using results from other trusted sources. The trusted party may provide CSEs at MTC device 105-d, or other CSEs 975 with an indication that the XSD is safe. In some examples, field domain CSEs may be configured with the addresses of the trusted parties applicable for that CSE.

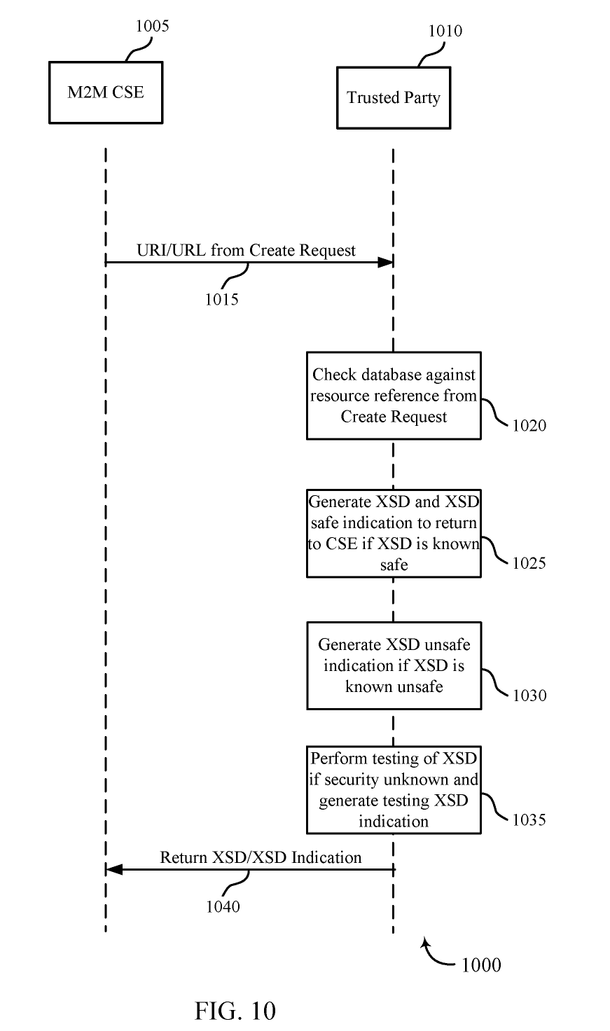

FIG. 10 illustrates an example of a process flow 1000 for customized resource types for M2M communication in accordance with various aspects of the present disclosure. Process flow 1000 may include a M2M CSE 1005 and a trusted party 1010. The M2M CSE 1005 may be a CSE that is present on an MTC device such as discussed above with respect to FIGS. 1-9. The M2M CSE 1005 may receive, for example, a create request to create a custom resource type from an AE of another MTC device, and may attempt to retrieve an XSD file associated with the custom resource type. In the example, of FIG. 10, the trusted party 1010 may receive resource reference information such as a URI/URL from the create request 1015. In some examples, the M2M CSE 1005 may submit the URI for the XSD to the trusted party 1010 along with an identity for the CSE implementation ID and hardware. The trusted party 1010 may then, as indicated at block 1020, check a database against the resource reference. In some examples, the trusted party 1010 may have information in the database that is compiled from its own testing, or from other trusted sources. The trusted party 1010 may, at block 1025, determine if the XSD is known to be safe for that implementation, and generate the XSD and an indication that the XSD is safe. If the XSD is known to be unsafe for that implementation, then the trusted party 1010 may generate an XSD unsafe indication or appropriate error indication, as indicated at block 1030. If the XSD has not been tested against the implementation, then the trusted party 1010 may begin the process of having the implementation tested against the indicated XSD and generate an indication that testing is in progress, according to block 1035. The trusted party 1010 may then send return XSD and/or XSD indication 1040 in accordance with the determinations made related to the resource reference. In some examples, the communication between the M2M CSE 1005 and trusted party 1010 is secure communication to help ensure that the M2M CSE 1005 receives the correct information back from the trusted party 1010. In some examples (e.g., in a closed system), a “hop-by-hop” security may be used for secure communications. In other examples (e.g., communication via untrusted MNs), end-to-end security may be used. In some examples, the trusted party 1010 may append a digital signature return indication, that the M2M CSE 1005 may verify.

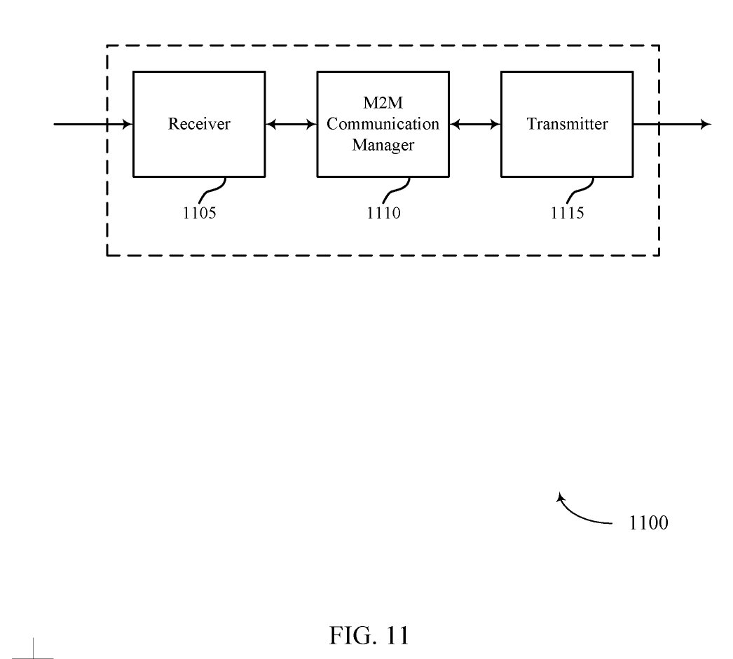

FIG. 11 shows a block diagram of a wireless device 1100 configured for customized resource types for machine-to-machine communication in accordance with various aspects of the present disclosure. Wireless device 1100 may be an example of aspects of a device 115 described with reference to FIGS. 1-8. Wireless device 1100 may include a receiver 1105, a M2M communications manager 1110, or a transmitter 1115. Wireless device 1100 may also include a processor. Each of these components may be in communication with each other.

The receiver 1105 may receive information such as packets, user data, or control information associated with various information channels (e.g., control channels, data channels, and information related to customized resource types for machine-to-machine communication, etc.). Information may be passed on to the M2M communications manager 1110, and to other components of wireless device 1100.

The M2M communications manager 1110 may receive a request to create a resource from a second MTC device, wherein the request comprises a resource reference and a content parameter, retrieve data associated with the resource from a first server, wherein the data is retrieved using the resource reference, generate the resource using the retrieved data, and send a response message comprising the content parameter to the second MTC device.

The transmitter 1115 may transmit signals received from other components of wireless device 1100. In some examples, the transmitter 1115 may be collocated with the receiver 1105 in a transceiver module. The transmitter 1115 may include a single antenna, or it may include a plurality of antennas.

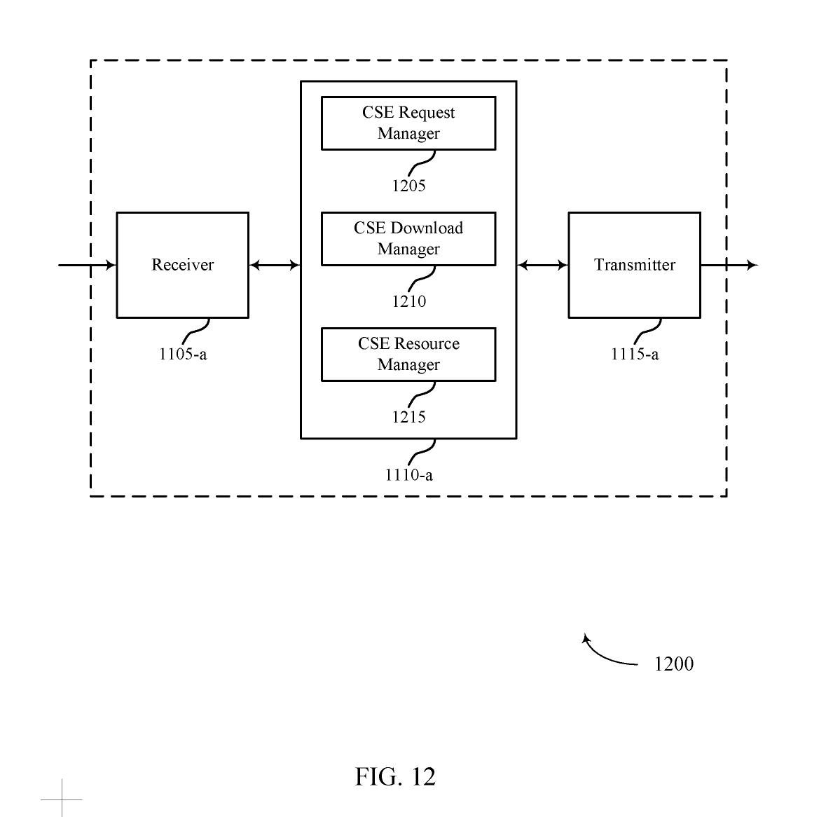

FIG. 12 shows a block diagram of a wireless device 1200 for customized resource types for machine-to-machine communication in accordance with various aspects of the present disclosure. Wireless device 1200 may be an example of aspects of a wireless device 1100, a device 115, or a device 105 described with reference to FIGS. 1-11. Wireless device 1200 may include a receiver 1105-a, a M2M communications manager 1110-a, or a transmitter 1115-a. Wireless device 1200 may also include a processor. Each of these components may be in communication with each other. The M2M communications manager 1110-a may also include a CSE request manager 1205, a CSE download manager 1210, and a CSE resource manager 1215.

The receiver 1105-a may receive information which may be passed on to M2M communications manager 1110-a, and to other components of wireless device 1200. The M2M communications manager 1110-a may perform the operations described with reference to FIG. 11. The transmitter 1115-a may transmit signals received from other components of wireless device 1200.

The CSE request manager 1205 may receive a request to create a resource from a second MTC device, wherein the request comprises a resource reference and a content parameter as described with reference to FIGS. 2-10. The CSE request manager 1205 may also send a response message comprising the content parameter to the second MTC device. The CSE request manager 1205 may also receive a subsequent request to create the resource from the second MTC device or a third MTC device, wherein the subsequent request comprises the content parameter. In some examples, receiving the request to create the resource from the second MTC device comprises receiving the request at a first layer entity of the first MTC device from a second layer entity of the second MTC device. In some examples, the first layer entity of the first MTC device comprises a service layer entity and the second layer entity of the second MTC device comprises an application layer entity. In some examples, the content parameter comprises a primitive content parameter. In some examples, the content parameter may comprise the resource reference. In other examples, the resource reference may comprise the content parameter. In some examples, the content parameter comprises at least one of a serialized Extensible Markup Language (XML) data string or a serialized JavaScript Object Notation (JSON) data string. In some examples, the content parameter may be supported by protocols at least one of Hypertext Transfer Protocol (HTTP), Constrained Application Protocol (CoAP), MQ Telemetry Transport (MQTT), or Web Socket. In some examples, the request to create the resource may be based at least in part on a parent resource associated with the second MTC device, and wherein the resource comprises a child resource.

The CSE download manager 1210 may retrieve data associated with the resource from a first server, wherein the data is retrieved using the resource reference as described with reference to FIGS. 2-10. In some examples, the resource reference comprises a Uniform Resource Indicator (URI) or a Uniform Resource Locator (URL). In some examples, the resource reference comprises an Extensible Markup Language (XML) Schema Definition (XSD) file or an indication of an XSD file.

The CSE resource manager 1215 may generate the resource using the retrieved data as described with reference to FIGS. 2-10. The CSE resource manager 1215 may also create a first instance of the resource using the content parameter. The CSE resource manager 1215 may also create a second instance of the resource using the content parameter. In some examples, the first server comprises a web server and the second server comprises a server that communicates using a machine-to-machine (M2M) communication protocol associated with the first MTC device and the second MTC device. In some examples, generating the resource using the retrieved data comprises generating a binding that enables the MTC device to validate a resource representation with respect to a cardinality, a data type and a parameter value range, and specifies how the resource is transported in request and response messages using an machine-to-machine (M2M) communication protocol associated with the first MTC device and the second MTC device. In some examples, sending the response message to the second MTC device comprises publishing an indication of the resource at the second server, wherein the indication may be responsive to the first topic published at the second server. The CSE resource manager 1215 may also publish a second topic that indicates an availability of the resource for subscription by the second MTC device or other MTC devices. In some examples, the first MTC device or the second MTC device comprises the second server. In some examples, the second server comprises an MQTT server. In some examples, the request to create the resource comprises a resource type identifier. In some examples, the resource type identifier may be selected from a range of resource type identifiers known a priori to the first MTC device and the second MTC device.

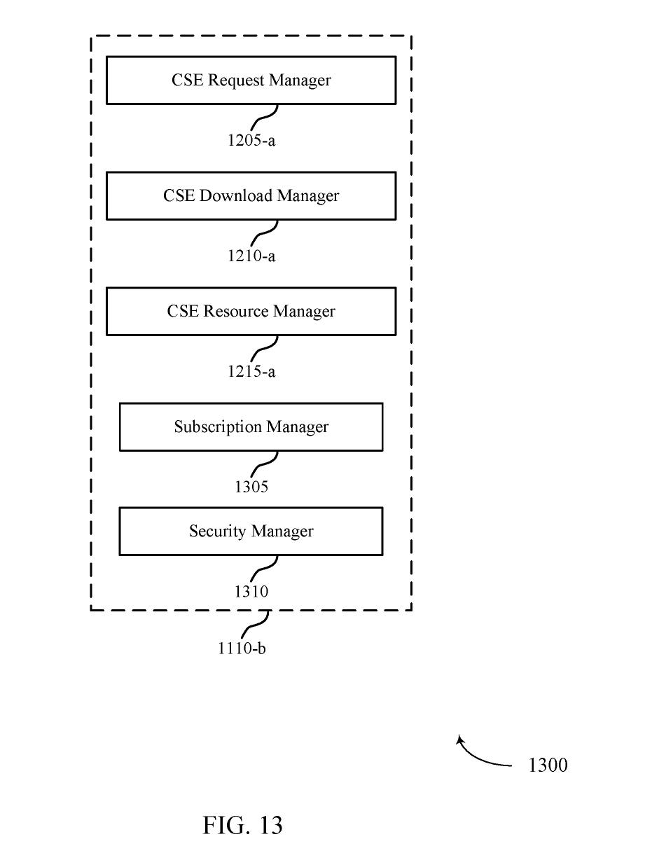

FIG. 13 shows a block diagram 1300 of a M2M communications manager 1110-b which may be a component of a wireless device 1100 or a wireless device 1200 for customized resource types for machine-to-machine communication in accordance with various aspects of the present disclosure. The M2M communications manager 1110-b may be an example of aspects of a M2M communications manager 1110 described with reference to FIGS. 11-12. The M2M communications manager 1110-b may include a CSE request manager 1205-a, a CSE download manager 1210-a, and a CSE resource manager 1215-a. Each of these modules may perform the functions described with reference to FIG. 12. The M2M communications manager 1110-b may also include and a subscription manager 1305 and a security manager 1310.

The subscription manager 1305 may couple to a second server that supports communication between the first MTC device and the second MTC device as described with reference to FIGS. 2-10. The subscription manager 1305 may also subscribe to a first topic published at the second server, wherein the request to create the resource is received based at least in part on the subscription to the first topic.

The security manager 1310 may determine that the data is safe for use by the first MTC device, such as through applying one or more tests or receiving an indication that one or more tests applied by a server have shown the data to be safe. In some examples, the security manager 1310 may provide information about the device implementation to a server, so the server can determine if the data is safe for use. The information about the device's implementation may include, for example, one or more identifiers for the software executing on the first MTC device or the device's hardware. In some examples, the server may return the requested data to the device, if the server determines that the data is safe for use by the device, in which case the server may return an appropriate indication to the device. In the event that the server determines the data is unsafe, the server may return an appropriate indication to the security manager 1310. Similarly, the server may return an indication to the security manager 1310 that the server cannot determine whether the data is safe or unsafe. In some examples, the security manager 1310 may include list of one or more addresses or identities of servers through which it may obtain the data. In the event that security manager 1310 receives an indication that a server cannot determine whether the data is safe or unsafe for use by the device, the security manager 1310 may repeat the process of requesting the data from another server in the list. If all the servers in the list indicate that they cannot determine whether the data is safe or unsafe for use by the device, the security manager 1310 may conclude that it cannot determine whether the data is safe or unsafe for use by the device. In some examples, the security manager may provide communication between the device and server that is secured, such as through TLS or DTLS, for example. In some examples the security manager 1310 may provide secure communications between the MTC device and server passes through intermediate devices with communications secured on a hop-by-hop basis from one device to the next. In other examples, the security manager 1310 may secure communications for at least a portion of the communications path using end-to-end security. In further examples, the security manager 1310 may provide security credentials for use in establishing secure communication with the server. In additional examples, the security manager 1310 may receive a digital signature appended to the data by the server, which may confirm secure communications.

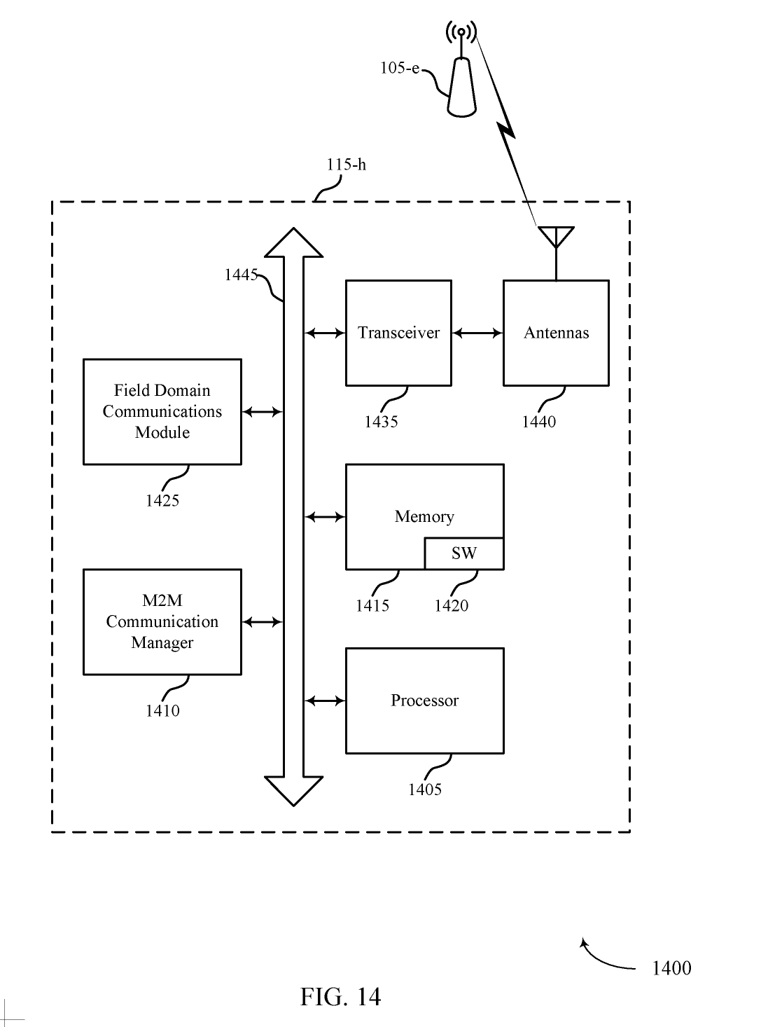

FIG. 14 shows a diagram of a system 1400 including a device 115 configured for customized resource types for machine-to-machine communication in accordance with various aspects of the present disclosure. System 1400 may include device 115-h, which may be an example of a wireless device 1100, a wireless device 1200, or a device 115 described with reference to FIGS. 1-13. Device 115-h may include a M2M communication manager 1410, which may be an example of a M2M communications manager 1110 described with reference to FIGS. 11-13. Device 115-h may also include a field domain communications module 1425, which may manage MTC field domain communications. Device 115-h may also include components for bi-directional voice and data communications including components for transmitting communications and components for receiving communications. For example, device 115-h may communicate bi-directionally with device 105-e.

Device 115-h may also include a processor 1405, and memory 1415 (including software (SW)) 1420, a transceiver 1435, and one or more antenna(s) 1440, each of which may communicate, directly or indirectly, with one another (e.g., via buses 1445). The transceiver 1435 may communicate bi-directionally, via the antenna(s) 1440 or wired or wireless links, with one or more networks, as described above. For example, the transceiver 1435 may communicate bi-directionally with another MTC device. The transceiver 1435 may include a modem to modulate the packets and provide the modulated packets to the antenna(s) 1440 for transmission, and to demodulate packets received from the antenna(s) 1440. While device 115-h may include a single antenna 1440, device 115-h may also have multiple antennas 1440 capable of concurrently transmitting or receiving multiple wireless transmissions.

The memory 1415 may include random access memory (RAM) and read only memory (ROM). The memory 1415 may store computer-readable, computer-executable software/firmware code 1420 including instructions that, when executed, cause the processor 1405 to perform various functions described herein (e.g., customized resource types for machine-to-machine communication, etc.). Alternatively, the software/firmware code 1420 may not be directly executable by the processor 1405 but cause a computer (e.g., when compiled and executed) to perform functions described herein. The processor 1405 may include an intelligent hardware device, (e.g., a central processing unit (CPU), a microcontroller, an application specific integrated circuit (ASIC), etc.).

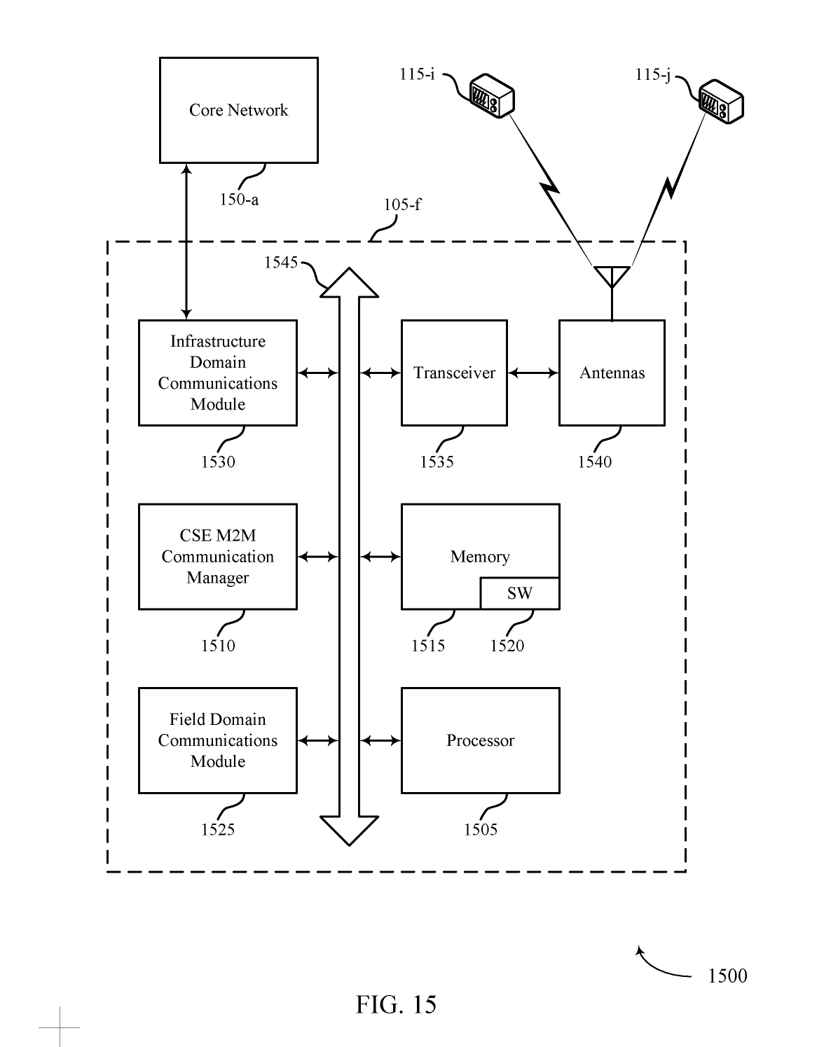

FIG. 15 shows a diagram of a system 1500 including an AP MTC device 105-f configured for customized resource types for machine-to-machine communication in accordance with various aspects of the present disclosure. System 1500 may include AP MTC device 105-f, which may be an example of a wireless device 1100, a wireless device 1200, or an AP 105 described with reference to FIGS. 1-13. AP MTC device 105-f may include a CSE M2M communication manager 1510, which may be an example of an M2M communications manager 1110 described with reference to FIGS. 11-13. AP MTC device 105-f may also include components for bi-directional voice or data communications including components for transmitting communications and components for receiving communications. For example, AP MTC device 105-f may communicate bi-directionally with UE MTC device 115-i or UE MTC device 115-j.

In some cases, AP MTC device 105-f may have one or more wired or wireless backhaul links. For example, AP MTC device 105-f may have a wired or wireless backhaul link between an infrastructure domain communications module 1530 and a core network for infrastructure domain communications. AP MTC device 105-f may also communicate with other MTC devices in the field domain, using wired or wireless communications utilizing field domain communications module 1525.

The AP MTC device 105-f may include a processor 1505, memory 1515 (including software (SW)1520), transceiver 1535, and antenna(s) 1540, which each may be in communication, directly or indirectly, with one another (e.g., over bus system 1545). The transceiver 1535 may be configured to communicate bi-directionally, via the antenna(s) 1540, with the other MTC devices 115-I and 115-j. The transceiver 1535 (or other components of the AP MTC device 105-f) may also be configured to communicate bi-directionally, via the antennas 1540, with one or more other AP MTC devices (not shown). The transceiver 1535 may include a modem configured to modulate the packets and provide the modulated packets to the antennas 1540 for transmission, and to demodulate packets received from the antennas 1540. The AP MTC device 105-f may include multiple transceivers 1535, each with one or more associated antennas 1540. The transceiver may be an example of a combined receiver 1105 and transmitter 1115 of FIG. 11.

The memory 1515 may include RAM and ROM. The memory 1515 may also store computer-readable, computer-executable software code 1520 containing instructions that are configured to, when executed, cause the processor 1510 to perform various functions described herein (e.g., customized resource types for machine-to-machine communication, security management, message routing, etc.). Alternatively, the software 1520 may not be directly executable by the processor 1505 but be configured to cause the computer, e.g., when compiled and executed, to perform functions described herein. The processor 1505 may include an intelligent hardware device, e.g., a CPU, a microcontroller, an ASIC, etc. The processor 1505 may include various special purpose processors such as encoders, queue processing modules, base band processors, radio head controllers, digital signal processor (DSPs), and the like.

The components of wireless device 1100, wireless device 1200, and M2M communications manager 1110 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

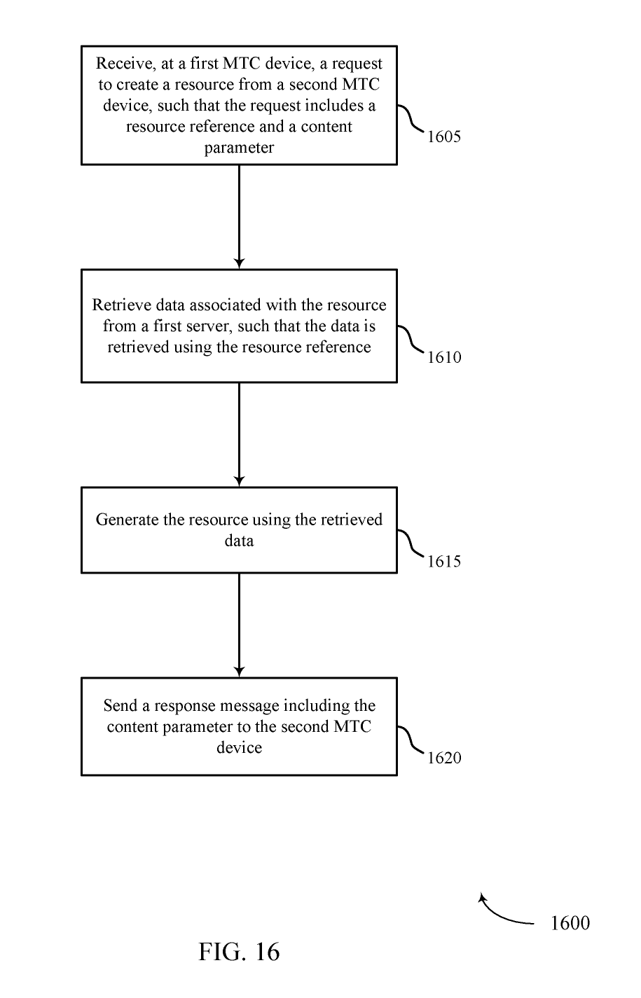

FIG. 16 shows a flowchart illustrating a method 1600 for customized resource types for machine-to-machine communication in accordance with various aspects of the present disclosure. The operations of method 1600 may be implemented by a MTC device, such as MTC device 115 or AP MTC device 105, or components thereof as described with reference to FIGS. 1-15. For example, the operations of method 1600 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects of the functions described below using special-purpose hardware.

At block 1605, a first MTC device may receive a request to create a resource from a second MTC device, wherein the request comprises a resource reference and a content parameter, as described with reference to FIGS. 2-10. In some examples, the operations of block 1605 may be performed by the CSE request manager 1205 as described with reference to FIG. 12. In some cases, receiving the request to create the resource from the second MTC device may include receiving the request at a first layer entity of the first MTC device from a second layer entity of the second MTC device.

At block 1610, the first MTC device may retrieve data associated with the resource from a first server, wherein the data is retrieved using the resource reference, as described with reference to FIGS. 2-10. In some examples, the operations of block 1610 may be performed by the CSE download manager 1210 as described with reference to FIG. 12.

At block 1615, the first MTC device may generate the resource using the retrieved data, as described with reference to FIGS. 2-10. In some examples, the operations of block 1615 may be performed by the CSE resource manager 1215 as described with reference to FIG. 12.

At block 1620, the first MTC device may send a response message comprising the content parameter to the second MTC device, as described with reference to FIGS. 2-10. In some examples, the operations of block 1620 may be performed by the CSE request manager 1205 as described with reference to FIG. 12.

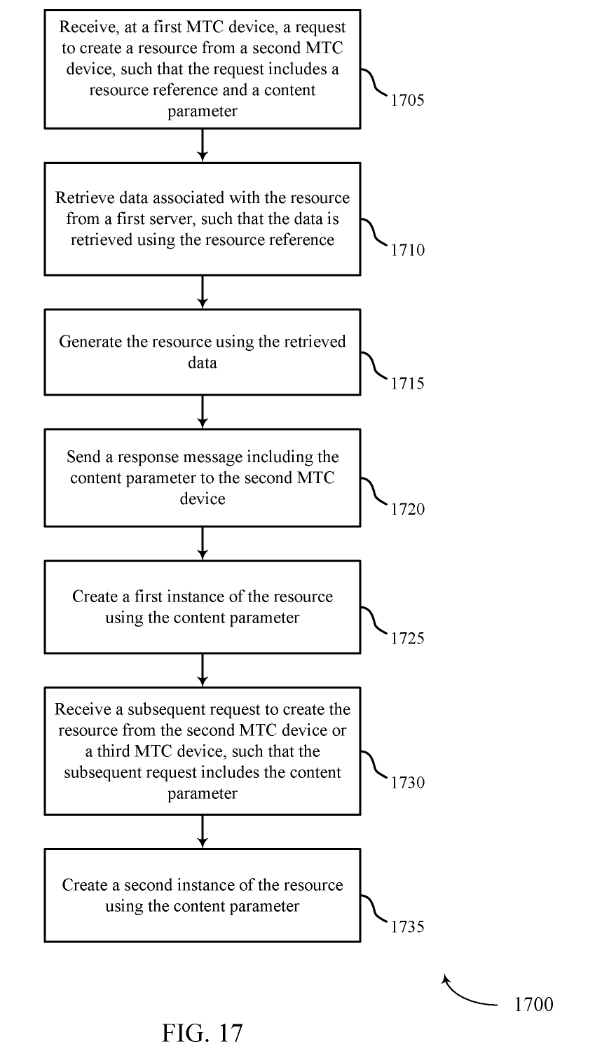

FIG. 17 shows a flowchart illustrating a method 1700 for customized resource types for machine-to-machine communication in accordance with various aspects of the present disclosure. The operations of method 1700 may be implemented by a MTC device, such as MTC device 115 or AP MTC device 105, or components thereof as described with reference to FIGS. 1-15. For example, the operations of method 1700 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects of the functions described below using special-purpose hardware. The method 1700 may also incorporate aspects of method 1600 of FIG. 16.

At block 1705, a first MTC device may receive a request to create a resource from a second MTC device, wherein the request comprises a resource reference and a content parameter, as described with reference to FIGS. 2-10. In some examples, the operations of block 1705 may be performed by the CSE request manager 1205 as described with reference to FIG. 12.

At block 1710, the first MTC device may retrieve data associated with the resource from a first server, wherein the data is retrieved using the resource reference, as described with reference to FIGS. 2-10. In some examples, the operations of block 1710 may be performed by the CSE download manager 1210 as described with reference to FIG. 12.

At block 1715, the first MTC device may generate the resource using the retrieved data, as described with reference to FIGS. 2-10. In some examples, the operations of block 1715 may be performed by the CSE resource manager 1215 as described with reference to FIG. 12.

At block 1720, the first MTC device may send a response message comprising the content parameter to the second MTC device, as described with reference to FIGS. 2-10. In some examples, the operations of block 1720 may be performed by the CSE request manager 1205 as described with reference to FIG. 12.

At block 1725, the first MTC device may create a first instance of the resource using the content parameter, as described with reference to FIGS. 2-10. In some examples, the operations of block 1725 may be performed by the CSE resource manager 1215 as described with reference to FIG. 12.

At block 1730, the first MTC device may receive a subsequent request to create the resource from the second MTC device or a third MTC device, wherein the subsequent request comprises the content parameter, as described with reference to FIGS. 2-10. In some examples, the operations of block 1730 may be performed by the CSE request manager 1205 as described with reference to FIG. 12.

At block 1735, the first MTC device may create a second instance of the resource using the content parameter, as described with reference to FIGS. 2-10. In some examples, the operations of block 1735 may be performed by the CSE resource manager 1215 as described with reference to FIG. 12.

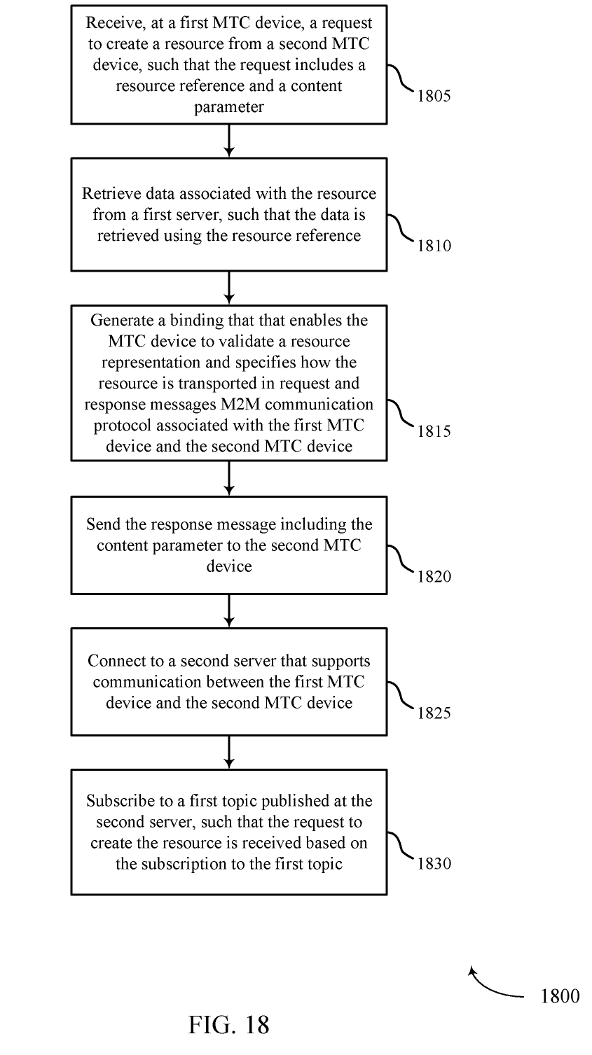

FIG. 18 shows a flowchart illustrating a method 1800 for customized resource types for machine-to-machine communication in accordance with various aspects of the present disclosure. The operations of method 1800 may be implemented by a MTC device, such as MTC device 115 or AP MTC device 105, or its components as described with reference to FIGS. 1-15. For example, the operations of method 1800 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects the functions described below using special-purpose hardware. The method 1800 may also incorporate aspects of methods 1600, and 1700 of FIGS. 16-17.

At block 1805, a first MTC device may receive a request to create a resource from a second MTC device, wherein the request comprises a resource reference and a content parameter, as described with reference to FIGS. 2-10. In some examples, the operations of block 1805 may be performed by the CSE request manager 1205 as described with reference to FIG. 12.

At block 1810, the first MTC device may retrieve data associated with the resource from a first server, wherein the data is retrieved using the resource reference, as described with reference to FIGS. 2-10. In some examples, the operations of block 1810 may be performed by the CSE download manager 1210 as described with reference to FIG. 12.

At block 1815, the first MTC device may generate a binding that enables the MTC device to validate a resource representation with respect to a cardinality, a data type and a parameter value range, and specifies how the resource is transported in request and response messages using an machine-to-machine (M2M) communication protocol associated with the first MTC device and the second MTC device, as described with reference to FIGS. 2-10. In some examples, the operations of block 1815 may be performed by the CSE resource manager 1215 as described with reference to FIG. 12.

At block 1820, the first MTC device may send a response message comprising the content parameter to the second MTC device, as described with reference to FIGS. 2-10. In some examples, the operations of block 1820 may be performed by the CSE request manager 1205 as described with reference to FIG. 12.

At block 1825, the first MTC device may connect to a second server that supports communication between the first MTC device and the second MTC device, as described with reference to FIGS. 2-10. In some examples, the operations of block 1825 may be performed by the subscription manager 1305 as described with reference to FIG. 13.

At block 1830, the first MTC device may subscribe to a first topic published at the second server, wherein the request to create the resource is received based at least in part on the subscription to the first topic, as described with reference to FIGS. 2-10. In some examples, the operations of block 1830 may be performed by the subscription manager 1305 as described with reference to FIG. 13.

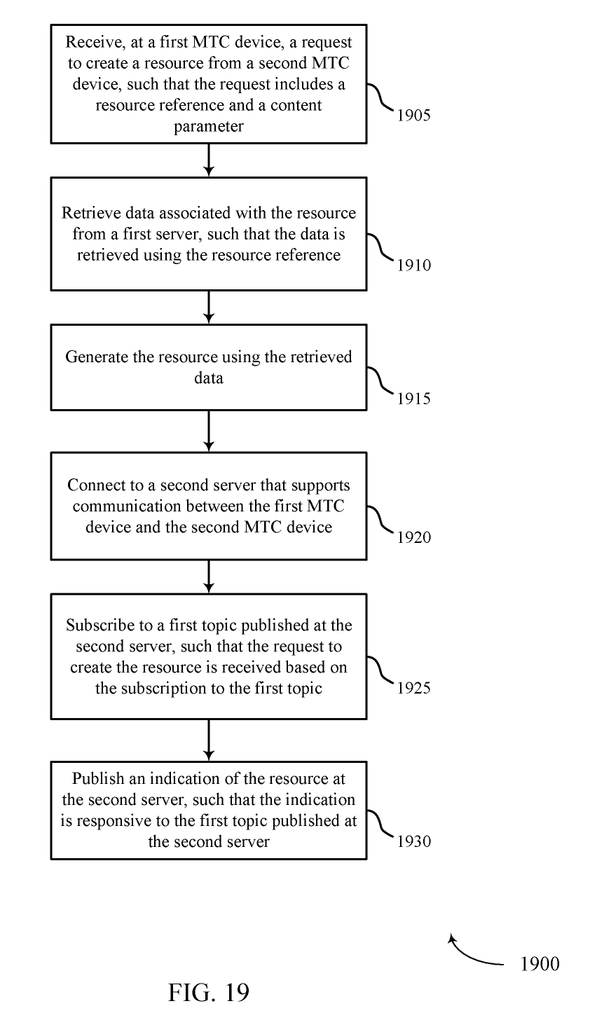

FIG. 19 shows a flowchart illustrating a method 1900 for customized resource types for machine-to-machine communication in accordance with various aspects of the present disclosure. The operations of method 1900 may be implemented by a MTC device, such as MTC device 115 or AP MTC device 105, or components thereof as described with reference to FIGS. 1-15. For example, the operations of method 1900 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects of the functions described below using special-purpose hardware. The method 1900 may also incorporate aspects of methods 1600, 1700, and 1800 of FIGS. 16-18.

At block 1905, a first MTC device may receive a request to create a resource from a second MTC device, wherein the request comprises a resource reference and a content parameter, as described with reference to FIGS. 2-10. In some examples, the operations of block 1905 may be performed by the CSE request manager 1205 as described with reference to FIG. 12.

At block 1910, the first MTC device may retrieve data associated with the resource from a first server, wherein the data is retrieved using the resource reference, as described with reference to FIGS. 2-10. In some examples, the operations of block 1910 may be performed by the CSE download manager 1210 as described with reference to FIG. 12.

At block 1915, the first MTC device may generate the resource using the retrieved data, as described with reference to FIGS. 2-10. In some examples, the operations of block 1915 may be performed by the CSE resource manager 1215 as described with reference to FIG. 12.

At block 1920, the first MTC device may connect to a second server that supports communication between the first MTC device and the second MTC device, as described with reference to FIGS. 2-10. In some examples, the operations of block 1920 may be performed by the subscription manager 1305 as described with reference to FIG. 13.

At block 1925, the first MTC device may subscribe to a first topic published at the second server, wherein the request to create the resource is received based at least in part on the subscription to the first topic, as described with reference to FIGS. 2-10. In some examples, the operations of block 1925 may be performed by the subscription manager 1305 as described with reference to FIG. 13.

At block 1930, the first MTC device may publish an indication of the resource at the second server, wherein the indication is responsive to the first topic published at the second server, as described with reference to FIGS. 2-10. In some examples, the operations of block 1930 may be performed by the subscription manager 1305 as described with reference to FIG. 13.

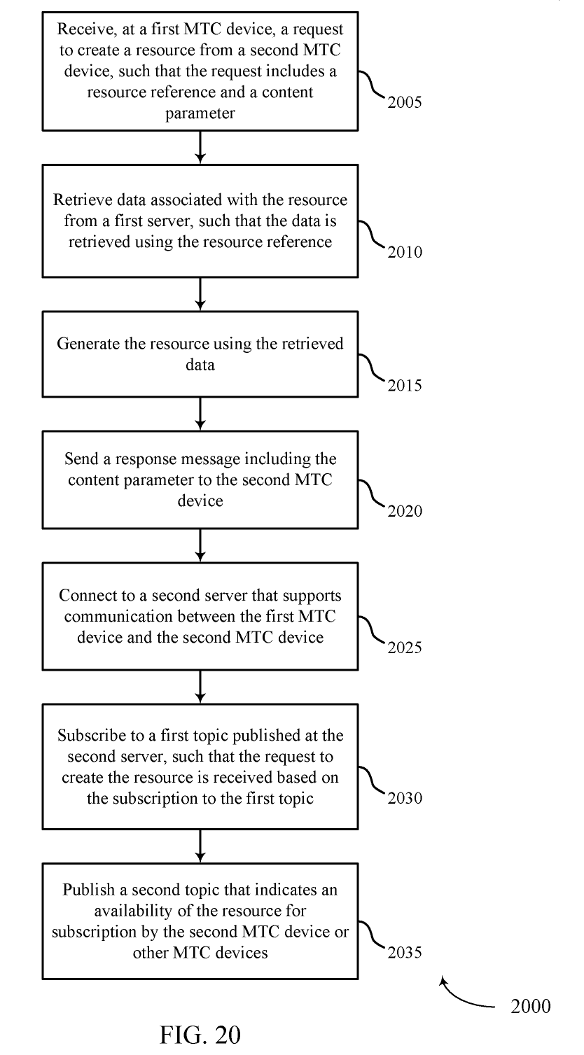

FIG. 20 shows a flowchart illustrating a method 2000 for customized resource types for machine-to-machine communication in accordance with various aspects of the present disclosure. The operations of method 2000 may be implemented by a MTC device, such as MTC device 115 or AP MTC device 105, or its components as described with reference to FIGS. 1-15. For example, the operations of method 2000 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects of the functions described below using special-purpose hardware. The method 2000 may also incorporate aspects of methods 1600, 1700, 1800, and 1900 of FIGS. 16-19.

At block 2005, a first MTC device may receive a request to create a resource from a second MTC device, wherein the request comprises a resource reference and a content parameter, as described with reference to FIGS. 2-10. In some examples, the operations of block 2005 may be performed by the CSE request manager 1205 as described with reference to FIG. 12.

At block 2010, the first MTC device may retrieve data associated with the resource from a first server, wherein the data is retrieved using the resource reference, as described with reference to FIGS. 2-10. In some examples, the operations of block 2010 may be performed by the CSE download manager 1210 as described with reference to FIG. 12.

At block 2015, the first MTC device may generate the resource using the retrieved data, as described with reference to FIGS. 2-10. In some examples, the operations of block 2015 may be performed by the CSE resource manager 1215 as described with reference to FIG. 12.

At block 2020, the first MTC device may send a response message comprising the content parameter to the second MTC device, as described with reference to FIGS. 2-10. In some examples, the operations of block 2020 may be performed by the CSE request manager 1205 as described with reference to FIG. 12.

At block 2025, the first MTC device may connect to a second server that supports communication between the first MTC device and the second MTC device, as described with reference to FIGS. 2-10. In some examples, the operations of block 2025 may be performed by the subscription manager 1305 as described with reference to FIG. 13.

At block 2030, the first MTC device may subscribe to a first topic published at the second server, wherein the request to create the resource is received based at least in part on the subscription to the first topic, as described with reference to FIGS. 2-10. In some examples, the operations of block 2030 may be performed by the subscription manager 1305 as described with reference to FIG. 13.

At block 2035, the first MTC device may publish a second topic that indicates an availability of the resource for subscription by the second MTC device or other MTC devices, as described with reference to FIGS. 2-10. In some examples, the operations of block 2035 may be performed by the CSE resource manager 1215 as described with reference to FIG. 12.

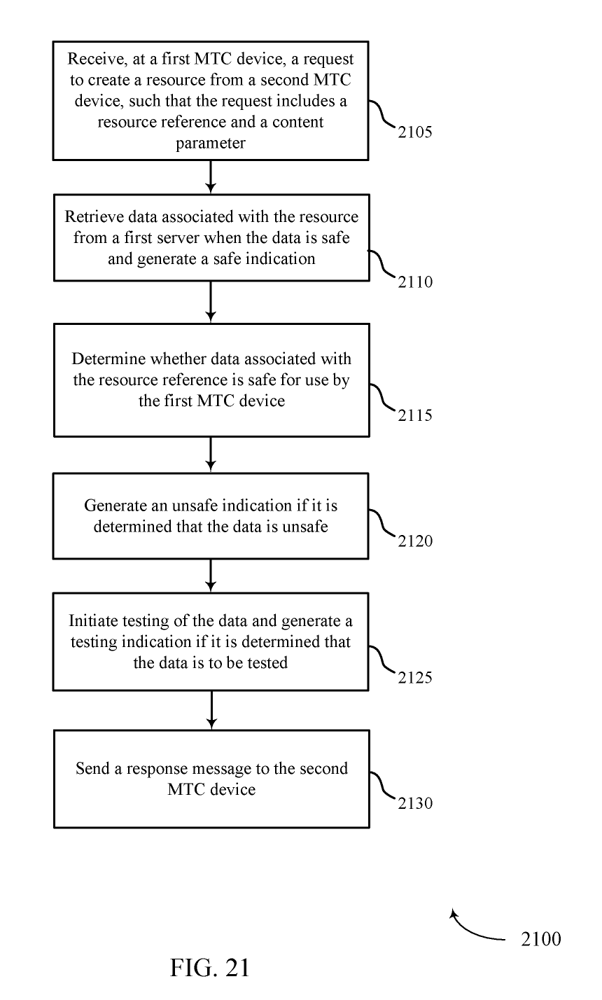

FIG. 21 shows a flowchart illustrating a method 2100 for customized resource types for machine-to-machine communication in accordance with various aspects of the present disclosure. The operations of method 2100 may be implemented by a MTC device, such as MTC device 115 or AP MTC device 105, or its components as described with reference to FIGS. 1-15. For example, the operations of method 2100 may be performed by the M2M communications manager 1110 as described with reference to FIGS. 11-13. In some examples, a MTC device may execute a set of codes to control the functional elements of the MTC device to perform the functions described below. Additionally or alternatively, the MTC device may perform aspects of the functions described below using special-purpose hardware. The method 2100 may also incorporate aspects of methods 1600, 1700, 1800, 1900, and 2000 of FIGS. 16-20. Further, while many of the operations of FIG. 21 are described with respect to an MTC server, such functions also may be performed, at least in part, by an M2M device (e.g., an AE at an MTC device in the field domain).

At block 2105, a first MTC device may receive a request to create a resource from a second MTC device, wherein the request comprises a resource reference and a content parameter, as described with reference to FIGS. 2-10. In some examples, the operations of block 2105 may be performed by the CSE request manager 1205 as described with reference to FIG. 12.

At block 2110, the first MTC device may retrieve data associated with the resource from a first server when the data is safe, and generate a safe indication, as described with reference to FIGS. 2-10. In some examples, the operations of block 2110 may be performed by the CSE download manager 1210 as described with reference to FIG. 12.

At block 2115, the first server may determine whether data associated with the resource reference is safe for use by the first MTC device, as described with reference to FIGS. 2-10. In some examples, the operations of block 2115 may be performed by the security manager 1310 as described with reference to FIG. 13.

At block 2120, the first server may generate an unsafe indication if it is determined that the data is unsafe, as described with reference to FIGS. 2-10. In some examples, the operations of block 2120 may be performed by the security manager 1310 as described with reference to FIG. 13.

At block 2125, the first server may initiate testing of the data and generate a testing indication if it is determined that the data is to be tested, as described with reference to FIGS. 2-10. In some examples, the operations of block 2125 may be performed by the security manager 1310 as described with reference to FIG. 13.

At block 2130, the first server may send a response message to the second MTC device, as described with reference to FIGS. 2-10. In some examples, the operations of block 2130 may be performed by the security manager 1310 as described with reference to FIG. 13 and the receiver of the response message may be the CSE request manager 1205 as described with reference to FIG. 12.

Thus, methods 1600, 1700, 1800, 1900, 2000, and 2100 may provide for customized resource types for machine-to-machine communication. It should be noted that methods 1600, 1700, 1800, 1900, 2000, and 2100 describe possible implementation, and that the operations and the steps may be rearranged or otherwise modified such that other implementations are possible. In some examples, aspects from two or more of the methods 1600, 1700, 1800, 1900, 2000, and 2100 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

What is claimed is:

1. A method for wired or wireless communication at a first machine type communication (MTC) device, comprising:
receiving a request from a second MTC device to create a resource, wherein the request comprises a resource reference and a content parameter;
retrieving data associated with the resource from a first server, wherein the data is retrieved using the resource reference;
generating the resource using the retrieved data; and
sending a response message comprising the content parameter to the second MTC device.

2. The method of claim 1, wherein the content parameter comprises:
the resource reference.

3. The method of claim 1, further comprising:
creating a first instance of the resource using the content parameter.

4. The method of claim 3, further comprising:
receiving a subsequent request from the second MTC device or a third MTC device to create the resource, wherein the subsequent request comprises the content parameter; and
creating a second instance of the resource using the content parameter.

5. The method of claim 1, further comprising:
connecting to a second server that supports communication between the first MTC device and the second MTC device; and
subscribing to a first topic published at the second server, wherein the request to create the resource is received based at least in part on the subscription to the first topic.

6. The method of claim 5, wherein the first server comprises a web server and the second server comprises a server that communicates using a machine-to-machine (M2M) communication protocol associated with the first MTC device and the second MTC device.

7. The method of claim 5, wherein generating the resource using the retrieved data comprises:
generating a binding that enables the MTC device to validate a resource representation with respect to a cardinality, a data type and a parameter value range, and specifies how the resource is transported in request and response messages using an machine-to-machine (M2M) communication protocol associated with the first MTC device and the second MTC device.

8. The method of claim 5, wherein sending the response message to the second MTC device comprises:
publishing an indication of the resource at the second server, wherein the indication is responsive to the first topic published at the second server.

9. The method of claim 5, further comprising:
publishing a second topic that indicates an availability of the resource for subscription by the second MTC device or other MTC devices.

10. The method of claim 1, wherein receiving the request from the second MTC device to create the resource comprises:
receiving the request at a first layer entity of the first MTC device from a second layer entity of the second MTC device.

11. The method of claim 10, wherein the first layer entity of the first MTC device comprises a service layer entity and the second layer entity of the second MTC device comprises an application layer entity.

12. The method of claim 1, wherein the request to create the resource comprises a resource type identifier that is not known a priori to the second MTC device.

13. The method of claim 1, wherein the resource reference comprises a Uniform Resource Indicator (URI), a Uniform Resource Name (URN), or a Uniform Resource Locator (URL).

14. The method of claim 1, wherein the resource reference comprises an Extensible Markup Language (XML) Schema Definition (XSD) file, an indication of an XSD file, or a JavaScript Object Notation (JSON) Schema Definition file.

15. The method of claim 1, wherein the content parameter comprises at least one of a serialized Extensible Markup Language (XML) data string or a serialized JavaScript Object Notation (JSON) data string, and further wherein the content parameter is supported by protocols at least one of Hypertext Transfer Protocol (HTTP), Constrained Application Protocol (CoAP), MQ Telemetry Transport (MQTT), or Web Socket.

16. The method of claim 1, wherein the request to create the resource is based at least in part on a parent resource associated with the second MTC device, and wherein the resource comprises a child resource.

17. The method of claim 1, wherein retrieving the data using the resource reference comprises determining that the data is safe for use by the first MTC device.

18. The method of claim 17, wherein the first server returns an indication to the first MTC device that the first server determined that the data is safe for use by the first MTC device, that the first server determined that the data is unsafe for use by the first MTC device, or that the first server cannot determine whether the data is safe or unsafe for use by the first MTC device.

19. The method of claim 1, wherein the first MTC device is configured with a list of one or more addresses or identities of first servers through which it may obtain the data.

20. The method of claim 19, wherein the first MTC device, upon receiving an indication that one of the servers in the list cannot determine whether the data is safe or unsafe for use by the first MTC device, requests the data from another server in the list of one or more addresses or identities of first servers.

21. The method of claim 20, wherein retrieving the data comprises:
identifying that it cannot be determined whether the data is safe for use if each server in the list cannot determine whether the data is safe, and
returning an error indication to the second MTC device.

22. The method of claim 1, wherein the communication between the first MTC device and first server passes through one or more intermediate devices and is secured on a hop-by-hop basis from one device to the next or is secured for at least a portion of a communication path between the first MTC device and the first server by end-to-end security.

23. The method of claim 1, wherein the first MTC device is configured with security credentials for establishing secure communication with the first server.

24. The method of claim 1, wherein a digital signature is appended to the data by the first server.

25. An apparatus for wireless communication, comprising:
means for receiving a request from a second machine type communication (MTC) device to create a resource, wherein the request comprises a resource reference and a content parameter;
means for retrieving data associated with the resource from a first server, wherein the data is retrieved using the resource reference;
means for generating the resource using the retrieved data; and
means for sending a response message comprising the content parameter to the second MTC device.

26. The method of claim 25, wherein the content parameter comprises:
the resource reference.

27. An apparatus for wireless communication, comprising:
a processor;
memory in electronic communication with the processor; and
instructions stored in the memory and operable, when executed by the processor, to cause the apparatus to:
receive a request from a second machine type communication (MTC) device to create a resource, wherein the request comprises a resource reference and a content parameter;
retrieve data associated with the resource from a first server, wherein the data is retrieved using the resource reference;
generate the resource using the retrieved data; and
send a response message comprising the content parameter to the second MTC device.

28. The method of claim 27, wherein the content parameter comprises:
the resource reference.

29. A non-transitory computer-readable medium storing code for wireless communication, the code comprising instructions executable to:
receive a request from a second machine type communication (MTC) device to create a resource, wherein the request comprises a resource reference and a content parameter;
retrieve data associated with the resource from a first server, wherein the data is retrieved using the resource reference;
generate the resource using the retrieved data; and
send a response message comprising the content parameter to the second MTC device.

30. The method of claim 29, wherein the content parameter comprises:
the resource reference.
